(19) United States
(12) Patent Application Publication
(10) Pub. No.: US 2026/0337306 A1
(43) Pub. Date: Oct. 29, 2026

(54) CATALYSTS AND POLYMERIZATIONS FOR IMPROVED POLYOLEFINS

(71) Applicant: EXXONMOBIL TECHNOLOGY AND ENGINEERING COMPANY, Spring, TX (US)

(72) Inventors: Matthew W. Holtcamp, Humble, TX (US); Kevin A. Stevens, Raritan, NJ (US); Dongming Li, Houston, TX (US); Laughlin G. McCullough, League City, TX (US); Charles J. Harlan, Houston, TX (US)

(73) Assignee: EXXONMOBIL TECHNOLOGY AND ENGINEERING COMPANY, Spring, TX (US)

(21) Appl. No.: 19/485,606

(22) PCT Filed: May 14, 2024
(86) PCT No.: PCT/US2024/029285

§ 371 Date: Nov. 18, 2025

Related U.S. Application Data
(60) Provisional application No. 63/503,810, filed on May 23, 2023.

(51) Int. Cl. C08F 4/6592; B01J 31/16; C08F 210/16

(52) U.S. Cl. CPC C08F 4/65927; B01J 31/1616; C08F 210/16; B01J 2231/12; B01J 2531/48; B01J 2531/49

(57) ABSTRACT

This disclosure relates to catalysts, polyethylene polymers, polymerization processes for making such polyethylene polymers, and films made therefrom. In various embodiments, polymerization processes include dual catalyst polymerizations, such as those carried out by combining a base metallocene catalyst and trim metallocene catalyst, wherein the base catalyst may optionally be supported in a first catalyst mixture such as a solvent, and the trim catalyst can be added in varying ratios to the supported base catalyst. Polymerizations using the combinations of the base and trim catalysts such as those described herein can produce linear low density polyethylene copolymers having a moderate degree of long chain branching, which may exhibit improved processability in producing films. Further, films made from such polymers may exhibit improved properties such as superior shrink.

### CROSS-REFERENCE TO RELATED APPLICATION

This application claims the benefit of U.S. Provisional Application 63/503,810, filed May 23, 2023 and entitled “Catalysts and Polymerizations for Improved Polyolefins”, the entirety of which is incorporated by reference herein.

### FIELD

This disclosure relates to catalysts, catalyst systems, and polymerization processes for making polyethylene polymers.

### BACKGROUND

A linear low density polyethylene (LLDPE) is a substantially linear polymer composed of ethylene monomeric units and alpha-olefin comonomeric units. The typical comonomeric units used are derived from 1-butene, 1-hexene, or 1-octene. An LLDPE may be distinguished from a conventional low density polyethylene (LDPE) in several ways including their different manufacturing processes. In addition, LLDPE has little or no detectable long chain branching (LCB) per 1,000 carbon atoms, whereas conventional LDPEs contain a relatively high degree of long chain branching. Long chain branching provides reduced neck-in and increased draw stability during extrusion processes. In addition, LLDPEs often have a narrower molecular weight distribution (MWD) relative to MWD of LDPEs, especially metallocene-catalyzed LLDPEs (“mLLDPE”). LLDPEs also have different rheological and mechanical properties, such as tear properties, as compared to LDPEs.

While mLLDPEs typically provide superior mechanical properties to incumbent LDPEs in films and other articles made therefrom, they are generally more difficult to process than LDPEs, e.g., having lower melt strength (which can not only impact bubble stability in many film formation processes, but can also lead to melt fractures-surface roughness or similar irregularities—in films produced at typical commercial extrusion rates).

Thus, various levels of LDPE have been blended with mLLDPEs to increase melt strength, to increase shear sensitivity, e.g. to increase flow at commercial shear rates in extruders, and to reduce the tendency to melt fracture. However, such blending generally has a negative impact on mechanical properties of films made from the polymers. Indeed, it has been a challenge to improve mLLDPE processability without sacrificing physical properties.

Comparing LLDPEs to one another, an LLDPE having a higher melt index is better for processing, and a combination of higher melt index and lower density is particularly good for cast film applications. However, less long chain branching can lead to reduced film properties, e.g., tear properties in films/articles made therefrom. Indeed, it is a challenge to find an LLDPE having a combination of density and melt index while still being commercially processable.

Some references of potential interest in this regard include: U.S. Pat. Nos. 6,479,424; 7,601,666; 8,829,115; 9,068,033; 10,633,471; 11,267,917; and 11,352,386; WO2021/257264; WO2022/015094; US2006/0122342; US2021/0332169; US2021/0388191; US2021/0395404; US2022/0185916; US2022/0315680; US2022/0064344; KR10-2022-0009900, KR10-2022-0009782; KR10-2021-0080974; KR10-2021-0038379; KR10-2020-0089599; KR10-2018-0063669; KR10-2007-0098276; and Foster, et al., Journal of Organometallic Chemistry, 571 (1998) 171.

Overall, there is a need for new LLDPEs having a combination of desirable properties (such as density, melt index properties, long chain branching) while also providing commercially desirable polymerizations and extrusions of the LLDPEs.

### SUMMARY

The present disclosure relates to catalysts, catalyst systems, and polymerization processes for making polyethylene polymers.

In some embodiments, a catalyst compound is represented by Formula (III):

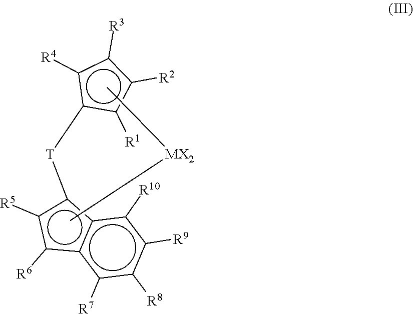

wherein:
M is a group 4 metal;
each of R¹, R², R³, R⁴, R⁵, R⁶, R⁷, R⁸, R⁹, and R¹⁰ is independently hydrogen, a substituted or unsubstituted hydrocarbyl, a substituted or unsubstituted heteroatom, or a substituted or unsubstituted heteroatom-containing group, or one or more of R⁵ and R⁶, R⁷ and R⁸, R⁸ and R⁹, and R⁹ and R¹⁰ are joined to form a substituted or unsubstituted completely saturated ring or a substituted or unsubstituted aromatic ring, wherein at least one of R⁵ or R⁶ is independently a substituted or unsubstituted aryl group or a substituted or unsubstituted heteroaryl group;
T is represented by formula R^{a}₂J, (R^{a})₄J₂, or (R^{a})₆J₃ wherein each J is independently carbon, silicon, or germanium, and each R^{a} is independently hydrogen, halide, a substituted or unsubstituted C₁ to C₄₀ hydrocarbyl, and furthermore, two R^{a} optionally can be joined to form a substituted or unsubstituted completely saturated ring or a substituted or unsubstituted partially saturated ring; and
each X is independently a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene.

In some embodiments, a catalyst compound is represented by Formula (IV):

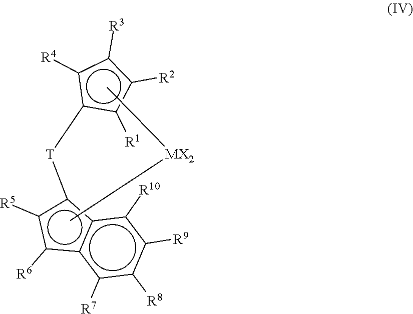

wherein:
M is a group 4 metal;
each of R¹, R², R³, R⁴, R⁵, R⁶, R⁷, R⁸, R⁹, and R¹⁰ is independently hydrogen, a substituted or unsubstituted hydrocarbyl, a substituted or unsubstituted heteroatom, or a substituted or unsubstituted heteroatom-containing group, or one or more of R⁵ and R⁶, R⁷ and R⁸, R⁸ and R⁹, and R⁹ and R¹⁰ are joined to form a substituted or unsubstituted completely saturated ring or a substituted or unsubstituted aromatic ring, wherein at least one of (1) R⁷ and R⁸, (2) R⁸ and R⁹, or (3) R⁹ and R¹⁰ are joined to form a substituted or unsubstituted completely saturated ring fused to the indenyl ring shown in Formula (IV);
T is represented by formula R^{a}₂J, (R^{a})₄J₂, or (R^{a})₆J₃ wherein each J is independently carbon, silicon, or germanium, and each R^{a} is independently hydrogen, halide, a substituted or unsubstituted C₁ to C₄₀ hydrocarbyl, or two R^{a} can form a substituted or unsubstituted completely saturated ring, a substituted or unsubstituted partially saturated ring, or a substituted or unsubstituted aromatic ring; and
each X is independently a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene.

In some embodiments, a method for producing a polyethylene copolymer includes contacting a first composition and a second composition in a line to form a third composition. The first composition includes a contact product of a first diluent, a first catalyst compound, a support material, and an activator. The second composition includes a contact product of a second diluent and a second catalyst compound that is a trim catalyst of the present disclosure. The method includes introducing the third composition from the line into a gas-phase fluidized bed reactor. The method includes exposing the third composition to polymerization conditions by polymerizing ethylene and at least one C₃-C₂₀ alpha-olefin by introducing the ethylene and the at least one C₃-C₂₀ alpha-olefin into the gas-phase fluidized bed reactor. The method includes obtaining the polyethylene copolymer.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a graph illustrating 4D GPC (population or mass of polymer chains as a function of log of molecular weight (LogM)) of polyethylene copolymer traces polyethylene copolymers made using base catalyst and/or base catalyst plus trim catalyst in accordance with various embodiments described herein. The y-axis value for population or mass of polymer chains may be labeled as d(wt fraction)/d(LogM) or equivalently as MWD(IR) to reflect that the y-axis value is molecular weight population or distribution, although it is noted that MWD in this context does not mean Mw/Mn as it does in other contexts herein. FIG. 1 also illustrates g′_{vis ave} values on its y-axis for the polyethylene copolymers made using base catalyst and/or base catalyst plus trim catalyst in accordance with various embodiments described herein.

FIG. 2 is a graph illustrating 4D GPC (population or mass of polymer chains as a function of log of molecular weight (LogM)) of polyethylene copolymer traces polyethylene copolymers made using base catalyst and/or base catalyst plus trim catalyst in accordance with various embodiments described herein. The y-axis value for population or mass of polymer chains may be labeled as d(wt fraction)/d(LogM) or equivalently as MWD(IR) to reflect that the y-axis value is molecular weight population or distribution, although it is noted that MWD in this context does not mean Mw/Mn as it does in other contexts herein. FIG. 2 also illustrates g′_{vis ave} values on its y-axis for the polyethylene copolymers made using base catalyst and/or base catalyst plus trim catalyst in accordance with various embodiments described herein.

FIG. 3 is a graph illustrating TREFIR5 Overlay of polyethylene copolymers made using a single catalyst and of polyethylene copolymers made using base catalyst plus trim catalyst in accordance with various embodiments described herein.

FIG. 4 is a graph illustrating TREFIR5 overlay of polyethylene copolymers made using a single catalyst and of polyethylene copolymers made using base catalyst plus trim catalyst in accordance with various embodiments described herein.

FIG. 5 is a graph illustrating pull off speed versus force of example polymers, and also including pull off speed versus force for two commercial polyethylenes: LD103.09 and Exceed™ 1018 MA.

FIG. 6 is a graph illustrating TREFIR5 overlay of polyethylenes copolymers made using a single catalyst and of polyethylene copolymers made using base catalyst plus trim catalyst in accordance with various embodiments described herein.

FIG. 7 is a graph illustrating overlay of TREFIR5 overlay of polyethylenes copolymers made using a single catalyst and of polyethylene copolymers made using base catalyst plus trim catalyst in accordance with various embodiments described herein.

### DETAILED DESCRIPTION

Various embodiments, versions of the disclosed compounds, processes, and articles of manufacture, will now be described, including specific embodiments and definitions that are adopted herein. While the following detailed description gives specific embodiments, those skilled in the art should appreciate that these embodiments are exemplary only, and that embodiments of the present disclosure can be practiced in other ways. Any reference to embodiments may refer to one or more, but not necessarily all, of the compounds, processes, or articles of manufacture defined by the claims. The use of headings is for purposes of convenience only and does not limit the scope of the present disclosure.

This disclosure relates to catalysts, catalyst systems and polymerization processes for making polyethylene polymers. Polyethylene polymers are copolymers formed by dual catalyst systems, especially such systems provided to a polymerization reactor using “trim” processes, and the polyethylene polymers have a combination of low density, low melt index, high melt index ratio, and controllable long chain branching (introduced by a trim process) while also providing commercially desirable polymerizations and extrusions of the polyethylene copolymers.

As compared to conventional LLDPEs, polyethylene copolymers of the present disclosure exhibit increased long chain branching (also referred to as “LCB”) in the copolymers, providing reduced neck-in and increased draw stability. Polyethylene copolymers of the present disclosure can exhibit lower zero shear viscosity, leading to lower motor torque and lower melt pressures and melt temperatures during extrusion, providing increased output of the extruded polyethylene copolymer product. In addition, because LCB is controlled (adjustable, e.g., by trim processes), advantageous tear properties can be likewise controlled (adjustable) to a desired polymer end use (e.g., shrink wrap film). For example, a reduction in motor torque and melt pressure may be observed during cast film fabrication due to increased polymer LCB. The LCB can be evidenced through, e.g., a high melt index ratio and/or rheology characteristics as shown by small angle oscillatory shear (SAOS) experiments (for instance, ratio of η_{0.01}/η₁₀₀, the complex viscosity recorded at shear rates of 0.01 and 100 rad/s, respectively, as well as in Van Gurp Palmen plots of phase angle vs. complex modulus, which track viscosity responses in the polymer to applied shear).

In addition, it has been discovered that polyethylene copolymers of the present disclosure can provide excellent shear thinning characteristics; and furthermore can be used to produce blown films having excellent bubble stability and/or little or no melt fracture. Polyethylene copolymers of the present disclosure further can provide films formed with reduced motor load and melt pressure (which increases throughput) due to improved flow behavior, as compared to conventional LLDPEs. For example, a reduction in melt pressure and decrease in melt temperature may be provided during blown film fabrication. Films of the present disclosure can be particularly useful as shrink wrap films (improved by the presence of LCB in the polyethylene copolymers of the present disclosure).

Indeed, catalysts (e.g., used for trim processes) and processes of the present disclosure can provide trimming (e.g., in-line) of a catalyst that promotes LCB onto a supported catalyst to, for example, control (adjust) the melt index ratio of the polyethylene copolymer that is formed in the reactor. The catalysts used for trimming can provide different molecular weight capabilities as compared to, for example, the in-line supported catalyst. Different molecular weight capabilities of the catalysts provides bimodal composition distribution of the polyethylene copolymer that is formed in the reactor.

### Definitions

As used herein, an “olefin,” alternatively referred to as “alkene,” is a linear, branched, or cyclic compound of carbon and hydrogen having at least one double bond. For purposes of this specification and the claims appended thereto, when a polymer or copolymer is referred to as “comprising” an olefin, the olefin present in such polymer or copolymer is the polymerized form of the olefin. For example, when a copolymer is described as having an “ethylene” content of 35 wt % to 55 wt %, it is understood that the mer unit in the copolymer is derived from ethylene in the polymerization reaction and the derived units are present at 35 wt % to 55 wt %, based upon the weight of the copolymer.

As used herein, the terms “polyethylene polymer,” “polyethylene copolymer,” “polyethylene,” “ethylene polymer,” “ethylene copolymer,” and “ethylene based polymer” mean a polymer or copolymer comprising at least 50 mol % ethylene units, or at least 70 mol % ethylene units, or at least 80 mol % ethylene units, or at least 90 mol % ethylene units, or at least 95 mol % ethylene units or 100 mol % ethylene units (in the case of a homopolymer).

As used herein, a “polymer” may refer to homopolymers, copolymers, interpolymers, terpolymers, etc. A “polymer” has two or more of the same or different monomer units. A “homopolymer” is a polymer having monomer units that are the same. A “copolymer” is a polymer having two or more monomer units that are different from each other. A “terpolymer” is a polymer having three monomer units that are different from each other. The term “different” as used to refer to monomer units indicates that the monomer units differ from each other by at least one atom or are different isomerically. Accordingly, the definition of copolymer, as used herein, includes terpolymers and the like. Likewise, the definition of polymer, as used herein, includes copolymers and the like.

As used herein, an ethylene polymer having a density of more than 0.860 to less than 0.910 g/cm³ is referred to as an ethylene plastomer or plastomer; an ethylene polymer having a density of 0.910 to 0.925 g/cm³ is referred to as a “linear low density polyethylene” (LLDPE) when substantially linear (having minor or no long chain branching) as is typically the case for Ziegler-Nata or metallocene-catalyzed PE or branched low density polyethylene (LDPE) when significantly branched (having a high degree of long chain branching), as is often the case with free-radical polymerized PE; 0.925 to 0.940 g/cm³ is referred to as a “medium density polyethylene” (MDPE); and an ethylene polymer having a density of more than 0.940 g/cm³ is referred to as a “high density polyethylene” (HDPE). Density is determined according to ASTM D792. Specimens are prepared according to ASTM D4703-Annex 1 Procedure C followed by conditioning according to ASTM D618-Procedure A prior to testing.

As used herein, and unless otherwise specified, the term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated or unsaturated), including mixtures of hydrocarbon compounds having different values of n.

As used herein, a composition or film “free of” a component refers to a composition/film substantially devoid of the component, or comprising the component in an amount of less than about 0.01 wt %, by weight of the total composition.

As used herein, the term “polymerization conditions” refers to conditions conducive to the reaction of one or more olefin monomers when contacted with an activated olefin polymerization catalyst to produce a polyolefin polymer, including a skilled artisan's selection of temperature, pressure, reactant concentrations, optional solvent/diluents, reactant mixing/addition parameters, and other conditions within at least one polymerization reactor.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, “in a range” or “within a range” includes every point or individual value between its end points even though not explicitly recited and includes the end points themselves. Thus, every point or individual value may serve as its own lower or upper limit combined with any other point or individual value or any other lower or upper limit, to recite a range not explicitly recited.

For the purposes of the present disclosure, the numbering scheme for the Periodic Table Groups is used as described in Chemical and Engineering News, 63 (5), pg. 27 (1985).

The following abbreviations may be used herein: Me is methyl, Et is ethyl, Ph is phenyl, tBu is tertiary butyl, PDI is polydispersity index, MAO is methylalumoxane, SMAO is supported methylalumoxane, NMR is nuclear magnetic resonance, ppm is part per million, THF is tetrahydrofuran.

As used herein, olefin polymerization catalyst(s) refer to any catalyst, such as an organometallic complex or compound that is capable of coordination polymerization addition where successive monomers are added in a monomer chain at the organometallic active center.

The terms “substituent,” “radical,” “group,” and “moiety” may be used interchangeably.

The term “alpha-olefin” refers to an olefin having a terminal carbon-to-carbon double bond in the structure thereof ((R″R′″)—C═CH₂, where R″ and R″ can be independently hydrogen or any hydrocarbyl group; such as R″ is hydrogen and R′″ is an alkyl group). A “linear alpha-olefin” is an alpha-olefin defined in this paragraph wherein R″ is hydrogen, and R′″ is hydrogen or a linear alkyl group.

For the purposes of the present disclosure, ethylene shall be considered an alpha-olefin.

As used herein, and unless otherwise specified, the term “Cn” means hydrocarbon(s) having n carbon atom(s) per molecule, wherein n is a positive integer. The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and or unsaturated), including mixtures of hydrocarbon compounds having different values of n. Likewise, a “Cₘ-C_{y}” group or compound refers to a group or compound including carbon atoms at a total number thereof from m to y. Thus, a C₁-C₅₀ alkyl group refers to an alkyl group including carbon atoms at a total number thereof of about 1 to about 50.

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halide (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halide, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted aromatic,” means an aromatic group having 1 or more hydrogen groups replaced by a hydrocarbyl, substituted hydrocarbyl, heteroatom or heteroatom containing group.

The terms “hydrocarbyl radical,” “hydrocarbyl group,” or “hydrocarbyl” may be used interchangeably and are defined to mean a group including hydrogen and carbon atoms only. For example, a hydrocarbyl can be a C₁-C₁₀₀ radical that may be linear, branched, or cyclic, and when cyclic, aromatic or non-aromatic. Examples of such radicals may include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and aryl groups, such as phenyl, benzyl, naphthyl.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl. The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, phenoxyl.

The term “alkenyl” means a straight-chain, branched-chain, or cyclic hydrocarbon radical having one or more double bonds. These alkenyl radicals may be optionally substituted. Examples of suitable alkenyl radicals can include ethenyl, propenyl, allyl, 1,4-butadienyl, cyclopropenyl, cyclobutenyl, cyclopentenyl, cyclohexenyl, cycloctenyl, including their substituted analogues.

The terms “alkyl radical,” “alkyl group,” and “alkyl” are used interchangeably throughout this disclosure. For purposes of this disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, including their substituted analogues. Some examples of alkyl may include 1-methylethyl, 1-methylpropyl, 1-methylbutyl, 1-ethylbutyl, 1,3-dimethylbutyl, 1-methyl-1-ethylbutyl, 1,1-diethylbutyl, 1-propylpentyl, 1-phenylethyl, i-propyl, 2-butyl, sec-pentyl, sec-hexyl, and the like.

The term “aryl” or “aryl group” means an aromatic ring and the substituted variants thereof, such as phenyl, 2-methyl-phenyl, xylyl, 4-bromo-xylyl. Likewise, “heteroaryl” means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

Where isomers of a named alkyl, alkenyl, alkoxide, or aryl group exist (e.g., n-butyl, iso-butyl, sec-butyl, and tert-butyl), reference to an alkyl, alkenyl, alkoxide, or aryl group without specifying a particular isomer (e.g., butyl) expressly discloses all isomers (e.g., n-butyl, iso-butyl, sec-butyl, and tert-butyl).

The term “ring atom” means an atom that is part of a cyclic ring structure. By this definition, a benzyl group has six ring atoms and tetrahydrofuran has five ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring. Other examples of heterocycles may include pyridine, imidazole, and thiazole.

As used herein, Mn is number average molecular weight, Mw is weight average molecular weight, and Mz is z average molecular weight, wt % is weight percent, and mol % is mole percent. Molecular weight distribution (MWD), also referred to as polydispersity (PDI), is defined to be Mw divided by Mn. Unless otherwise noted, all molecular weight units (e.g., Mw, Mn, Mz) are g/mol.

The terms “catalyst compound”, “catalyst complex”, “transition metal complex”, “transition metal compound”, “precatalyst compound”, and “precatalyst complex” are used interchangeably.

A “catalyst system” is a combination of at least one catalyst compound, optionally at least one activator, an optional coactivator, and an optional support material. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The catalyst compound may be neutral as in a precatalyst, or a charged species with a counter ion as in an activated catalyst system. For the purposes of the present disclosure and the claims thereto, when catalyst systems are described as including neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein are intended to embrace both neutral and ionic forms of the catalyst compounds and activators.

An “anionic ligand” is a negatively charged ligand which donates one or more pairs of electrons to a metal ion. A “Lewis base” or “neutral donor ligand” is a neutrally charged ligand which donates one or more pairs of electrons to a metal ion. Examples of Lewis bases include ethylether, trimethylamine, pyridine, tetrahydrofuran, dimethylsulfide, and triphenylphosphine. The term “heterocyclic Lewis base” refers to Lewis bases that are also heterocycles. Examples of heteroyclic Lewis bases include pyridine, imidazole, thiazole, and furan.

A scavenger is a compound that can be added to facilitate polymerization by scavenging impurities. Some scavengers may also act as activators and may be referred to as coactivators. A coactivator, that is not a scavenger, may also be used in conjunction with an activator in order to form an active catalyst. In at least one embodiment, a coactivator can be pre-mixed with the transition metal compound to form an alkylated transition metal compound.

The term “continuous” means a system that operates without interruption or cessation for an extended period of time. For example a continuous process to produce a polymer would be one where the reactants are continually introduced into one or more reactors and polymer product is continually withdrawn.

A solution polymerization means a polymerization process in which the polymer is dissolved in a liquid polymerization medium, such as an inert diluent or monomer(s) or their blends. A solution polymerization can be homogeneous. A homogeneous polymerization is one where the polymer product is dissolved in the polymerization medium. Suitable systems may be not turbid as described in J. Vladimir Oliveira, C. Dariva and J. C. Pinto, Ind. Eng. Chem. Res., 2000, Vol. 29, p. 4627.

A bulk polymerization means a polymerization process in which the monomers and or comonomers being polymerized are used as a solvent or diluent using little or no inert solvent as a solvent or diluent. A small fraction of inert solvent/diluent might be used as a carrier for catalyst and scavenger. A bulk polymerization system contains less than 25 wt % of inert solvent or diluent, such as less than 10 wt %, such as less than 1 wt %, such as 0 wt %.

The term “single catalyst compound” refers to a catalyst compound corresponding to a single structural formula, although such a catalyst compound may comprise and be used as a mixture of isomers, e.g., stereoisomers.

A catalyst system that utilizes a single catalyst compound means a catalyst system that is prepared using only a single catalyst compound in the preparation of the catalyst system. Thus, such a catalyst system is distinguished from, for example, “dual” catalyst systems, which are prepared using two catalyst compounds having different structural formulas, e.g., the connectivity between the atoms, the number of atoms, and/or the type of atoms in the two catalyst compounds is different. Thus, one catalyst compound is considered different from another if it differs by at least one atom, either by number, type, or connection. For example bisindenyl zirconium dichloride is different from (indenyl)(2-methylindenyl) zirconium dichloride which is different from (indenyl)(2-methylindenyl) hafnium dichloride. Catalyst compounds that differ only in that they are stereoisomers of each other are not considered to be different catalyst compounds. For example, rac-dimethylsilylbis(2-methyl 4-phenyl) hafnium dimethyl and meso-dimethylsilylbis(2-methyl 4-phenyl) hafnium dimethyl are considered to be not different.

The terms “cocatalyst” and “activator” are used herein interchangeably and are defined to be any compound which can activate any one of the catalyst compounds described above by converting the neutral catalyst compound to a catalytically active catalyst compound cation.

### Polymerization Processes

A polymerization process can include a gas phase polymerization reaction, and in particular a fluidized bed gas phase polymerization reaction. Generally, in a fluidized gas bed process used for producing polymers, a gaseous stream containing one or more monomers is continuously cycled through a fluidized bed in the presence of a catalyst under reactive conditions. In some embodiments, the reaction medium includes condensing agents, which are typically non-coordinating inert liquids that are converted to gas in the polymerization processes, such as isopentane, isohexane, or isobutane. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228; all of which are incorporated herein by reference.) The gas-phase polymerization may be carried out in any suitable reactor system, e.g., a stirred- or paddle-type reactor system. See U.S. Pat. Nos. 7,915,357; 8,129,484; 7,202,313; 6,833,417; 6,841,630; 6,989,344; 7,504,463; 7,563,851; and 8,101,691 for discussion of suitable gas phase fluidized bed polymerization systems, which are incorporated herein by reference.

In such polymerization processes, a gas-phase, fluidized-bed process is conducted by passing a stream containing ethylene and an olefin comonomer continuously through a fluidized-bed reactor under reaction conditions and in the presence of a catalyst composition at a velocity sufficient to maintain a bed of solid particles in a suspended state. A stream (which may be called a “cycle gas” stream) containing unreacted ethylene and olefin comonomer is continuously withdrawn from the reactor, compressed, cooled, optionally partially or fully condensed, and recycled back to the reactor. Prepared polyethylene copolymer is withdrawn from the reactor and replacement ethylene and olefin comonomer are added to the recycle stream. In some embodiments, gas inert to the catalyst composition and reactants is present in the gas stream.

The cycle gas can include induced condensing agents (ICA). An ICA is one or more non-reactive alkanes that are condensable in the polymerization process for removing the heat of reaction. In some embodiments, the non-reactive alkanes are selected from C₁-C₆ alkanes, e.g., one or more of propane, butane, isobutane, pentane, isopentane, hexane, as well as isomers thereof and derivatives thereof. In some instances, mixtures of two or more such ICAs may be particularly useful (e.g., propane and pentane, propane and butane, butane and pentane, etc.).

The reactor pressure during polymerization may be about 100 psig (680 kPag)-about 500 psig (3448 kPag), such as about 200 psig (1379 kPag)-about 400 psig (2759 kPag), such as about 250 psig (1724 kPag)-about 350 psig (2414 kPag). In some embodiments, the reactor is operated at a temperature of about 60° C. to about 120° C., such as about 60° C. to about 115° C., such as about 70° C. to about 110° C., such as about 70° C. to about 95° C., such as about 80° C. to about 90° C. A ratio of hydrogen gas to ethylene can be about 10 to about 30 ppm/mol %, such as about 15 to about 25 ppm/mol %, such as about 16 to about 20 ppm/mol %.

The mole percent of ethylene (based on total monomers) may be about 25-about 90 mole percent, such as about 50-about 90 mole percent, or about 70-about 85 mole percent, and the ethylene partial pressure (in the reactor) can be about 75 psia (517 kPa)-about 300 psia (2069 kPa), or about 100 psia-about 275 psia (689-1894 kPa), or about 150 psia-about 265 psia (1034-1826 kPa), or about 180 psia-about 200 psia. Ethylene concentration in the reactor can also range from about 35 mol %-about 95 mol %, such as within the range from a low of 35, 40, 45, 50, or 55 mol % to a high of 70, 75, 80, 85, 90, or 95 mol % and further where ethylene mol % is measured on the basis of total moles of gas in the reactor (including, if present, ethylene and/or comonomer gases as well as inert gases such as one or more of nitrogen, isopentane or other ICA(s), etc.); as with vol-ppm hydrogen, this measurement may for convenience be taken in the cycle gas outlet rather than in the reactor itself. Comonomer concentration can be about 0.2-about 1 mol %, such as from a low of 0.2, 0.3, 0.4 or 0.5 mol % to a high of 0.65, 0.70, 0.75, 0.80, 0.85, 0.90, 0.95, or 1.0 mol %.

### Polymerizations Using Trim

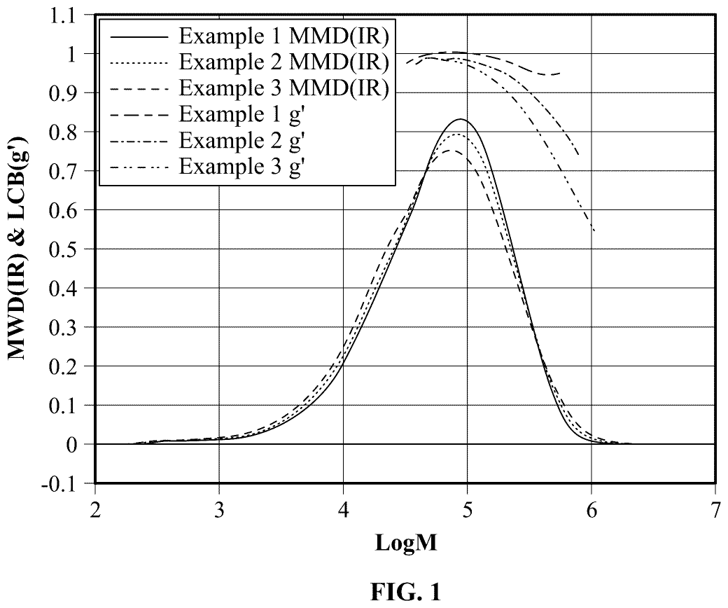

Polymerization processes of the present disclosure can be performed using a “trim” process. Trim processes are described, e.g., in U.S. Patent Publication No. 2021/0395404, especially in connection with FIG. 1 therein, and at Paragraphs [0113]-[0124] therein, which description is incorporated herein by reference. An overview of such processes of particular use for the present disclosure is also provided below.

For delivery of a catalyst slurry to a reactor, a high solids concentration of the slurry typically increases the slurry viscosity. A high solids concentration also increases the amount of foaming which is typically generated in a catalyst slurry vessel. A high slurry viscosity and foaming can cause handling problems, storage problems as well as reactor injection problems. Low viscosity diluents can be added to the slurry to reduce the viscosity. However, the reduced viscosity promotes settling of the slurry in the solution, which can result in plugging of reactor components and accumulation of solids on the walls of catalyst slurry vessels.

A second catalyst solution can be added (i.e. “trimmed”) to the slurry to adjust one or more properties “in-situ” of polymer being formed in a reactor. Such “trim” processes are very economical because they do not require a polymerization to cease in order to adjust polymer properties in the event a catalyst system is not behaving in a desirable way. However, a second catalyst is typically delivered to the slurry as a low viscosity solution, which can promote settling of the slurry solution and subsequent gelling and/or plugging of reactor components.

Accordingly, processes for polymerizing olefin(s) can include using dual catalyst systems (e.g., by supporting a second catalyst in situ). In particular, methods include combining a catalyst component slurry with a catalyst component solution (to “trim”) to form a third catalyst composition and introducing the third composition into a polymerization reactor (e.g., gas phase reactor).

In some embodiments, a method includes: contacting a first composition with a second composition in a line leading to the reactor to form a third composition. The first composition includes a first catalyst (or catalyst compound), a support, and a diluent. The first catalyst or catalyst compound may be referred to herein as a “primary catalyst” or “base catalyst.” The second composition includes a second catalyst (or catalyst compound) and a second diluent. The second catalyst or catalyst compound can be referred to as a “trim catalyst”, particularly insofar as in methods described herein, the trim process is preferably used to adjust ratio of first to second catalyst by increasing or decreasing relative amount of trim catalyst to primary catalyst. The method includes introducing the third composition from the line into a gas-phase fluidized bed reactor and exposing the third composition to polymerization conditions. The method includes obtaining a polyolefin.

Processes can include adjusting reactor conditions, such as an amount of second catalyst fed to the reactor (via the line to the reactor), to control one or more polymer properties of the polyolefin obtained from the reactor.

By using metallocene catalysts of the present disclosure as the second catalyst trimmed on-line at various ratios onto slurry feeding the first catalyst, or vice versa, along with varying reactor conditions involving temperature, reaction mixture component concentrations, and the like, beneficial polyolefin products may be formed.

Additionally, it should also be contemplated that for the distinct catalysts selected, some of the second catalyst may be initially co-deposited with the first catalyst on a common support, and the remaining amount of the first catalyst or second catalyst added as trim.

The catalyst system may include a catalyst compound in a slurry and an added solution catalyst component that is added to the slurry. Generally, the first catalyst and/or second catalyst will be supported in the initial slurry, depending on solubility. However, in at least one embodiment, the initial catalyst component slurry may have no catalysts. In this case, two or more solution catalysts may be added as “trim” to the slurry to cause each to be supported.

Furthermore, notwithstanding the above distinctions between “primary catalyst” or “base catalyst” and “trim catalyst” as noted above, it is contemplated that one could easily swap the role of primary catalysts described herein with trim catalysts, to achieve a similar effect (that is, in various embodiments, any “primary catalyst” described herein could be used as the “second catalyst” in methods just described; and any “trim catalyst” could be used as the “first catalyst” in methods just described).

The slurry may include one or more activators and supports, and one or more catalyst compounds. For example, the slurry may include two or more activators (such as alumoxane and a modified alumoxane) and a catalyst compound, or the slurry may include a supported activator and more than one catalyst compounds. In at least one embodiment, the slurry includes a support, an activator, and two catalyst compounds. In another embodiment the slurry includes a support, an activator and two different catalyst compounds, which may be added to the slurry separately or in combination. The slurry, containing silica and alumoxane, may be contacted with a catalyst compound, allowed to react, and thereafter the slurry is contacted with another catalyst compound, for example, as “trim.”

One or more diluents can be used to facilitate the combination of any two or more components of the catalyst system in the slurry or in the trim catalyst solution. For example, the single site catalyst compound and the activator can be combined together in the presence of toluene or another non-reactive hydrocarbon or hydrocarbon mixture to provide the catalyst mixture. In addition to toluene, other suitable diluents can include, but are not limited to, ethylbenzene, xylene, pentane, hexane, heptane, octane, other hydrocarbons, or any combination thereof. The support, either dry or mixed with toluene can then be added to the catalyst mixture or the catalyst/activator mixture can be added to the support.

The diluent can be or include mineral oil. Mineral oil can have a density of about 0.85 g/cm³ to about 0.9 g/cm³ at 25° C. according to ASTM D4052, such as about 0.86 g/cm³ to about 0.88 g/cm³. Mineral oil can have a kinematic viscosity at 25° C. of about 150 cSt to about 200 cSt according to ASTM D341, such as about 160 cSt to about 190 cSt, such as about 170 cSt. Mineral oil can have an average molecular weight of about 400 g/mol to about 600 g/mol according to ASTM D2502, such as about 450 g/mol to about 550 g/mol, such as about 500 g/mol. In at least one embodiment, a mineral oil is HYDROBRITE® 380 PO White Mineral Oil (“HB380”) from Sonneborn, LLC.

The diluent can further include a wax, which can provide increased viscosity to a slurry (such as a mineral oil slurry). A wax is a food grade petrolatum also known as petroleum jelly. A wax can be a paraffin wax. Paraffin waxes include SONO JELL® paraffin waxes, such as SONO JELL® 4 and SONO JELL® 9 from Sonneborn, LLC. In at least one embodiment, a slurry has 5 wt % or greater of wax, such as 10 wt % or greater, such as 25 wt % or greater, such as 40 wt % or greater, such as 50 wt % or greater, such as 60 wt % or greater, such as 70 wt % or greater. For example, a mineral oil slurry can have about 70 wt % mineral oil, about 10 wt % wax, and about 20 wt % supported catalyst(s) (e.g., supported dual catalysts). The increased viscosity provided by a wax in a slurry, such as a mineral oil slurry, provides reduced settling of supported catalyst(s) in a trim vessel or catalyst pot (for introducing supported catalyst to the line); while at the same time trim efficiency can be suitably maintained. In at least one embodiment, a wax has a density of about 0.7 g/cm³ (at 100° C.) to about 0.95 g/cm³ (at 100° C.), such as about 0.75 g/cm³ (at 100° C.) to about 0.87 g/cm³ (at 100° C.). A wax can have a kinematic viscosity of about 5 mm²/s (at 100° C.) to about 30 mm²/s (at 100° C.). A wax can have a boiling point of about 200° C. or greater, such as about 225° C. or greater, such as about 250° C. or greater. A wax can have a melting point of about 25° C. to about 100° C., such as about 35° C. to about 80° C.

The catalyst component solution (referred to as the “trim” solution) may include only catalyst compound(s) or may include an activator. In at least one embodiment, the catalyst compound(s) in the catalyst component solution is unsupported. The catalyst solution used in a trim process can be prepared by dissolving the catalyst compound and optional activators in a liquid diluent. The liquid diluent may be an alkane, such as a C₅ to C₃₀ alkane, or a C₅ to C₁₀ alkane. Cyclic alkanes such as cyclohexane and aromatic compounds such as toluene may also be used. Mineral oil may be used as a diluent alternatively or in addition to other alkanes such as a C₅ to C₃₀ alkane. Mineral oil can have a density of about 0.85 g/cm³ to about 0.9 g/cm³ at 25° C. according to ASTM D4052, such as about 0.86 g/cm³ to about 0.88 g/cm³. Mineral oil can have a kinematic viscosity at 25° C. of about 150 cSt to about 200 cSt according to ASTM D341, such as about 160 cSt to about 190 cSt, such as about 170 cSt. Mineral oil can have an average molecular weight of about 400 g/mol to about 600 g/mol according to ASTM D2502, such as about 450 g/mol to about 550 g/mol, such as about 500 g/mol. In at least one embodiment, a mineral oil is HYDROBRITE® 380 PO White Mineral Oil (“HB380”) from Sonneborn, LLC.

The solution used should be liquid under the conditions of polymerization and relatively inert. In at least one embodiment, the liquid utilized in the catalyst compound solution is different from the diluent used in the catalyst component slurry. In another embodiment, the liquid utilized in the catalyst compound solution is the same as the diluent used in the catalyst component solution.

In alternative embodiments, the catalyst is not limited to a slurry arrangement, as a mixed catalyst system may be made on a support and dried. The dried catalyst system can then be fed to the reactor through a dry feed system.

In gas-phase polyethylene production processes, it may be desirable to use one or more static control agents to aid in regulating static levels in the reactor. As used herein, a static control agent is a chemical composition which, when introduced into a fluidized bed reactor, may influence or drive the static charge (negatively, positively, or to zero) in the fluidized bed. The specific static control agent used may depend upon the nature of the static charge, and the choice of static control agent may vary dependent upon the polymer being produced and the single site catalyst compounds being used.

Control agents such as aluminum stearate may be used. The static control agent used may be selected for its ability to receive the static charge in the fluidized bed without adversely affecting productivity. Other suitable static control agents may also include aluminum distearate, ethoxylated amines, and anti-static compositions.

### Primary Catalysts

The catalysts employed in a polymerization of the present disclosure can be metallocene catalysts. Metallocene catalysts are well described, e.g., in US 2021/0395404 at Paragraphs [0066]-[0083], which description is incorporated herein by reference. Any metallocene catalyst in accordance with that description may be suitable as a primary catalyst in the systems and processes described herein. Of particular interest are metallocene catalysts having cyclopentadienyl (Cp) and/or indenyl (In) ligands, bridged or unbridged, bound to at least one Group 3 to Group 12 metal atom (preferably Zn, Hf, or Ti), and one or more (preferably two) leaving group(s) bound to the at least one metal atom (preferably wherein each leaving group is independently C₁ to C₄ alkyl, such as methyl, or halide, such as CL).

More particularly, a primary catalyst in accordance with various embodiments can include an unbridged hafnocene or zirconocene, such as the hafnocenes described in U.S. Pat. No. 7,078,467 at col. 3, line 62 to col. 4, line 51, which description is incorporated herein by reference, as well as the zirconocene analogues thereof; and/or the catalysts described in U.S. Pat. No. 6,936,675 at col. 4, line 22 to col. 7, line 36, which description is also incorporated herein by reference. For instance, a suitable primary catalyst can include an unbridged bis-indenyl hafnocene or zirconocene, such as one or more of the following:
bis(n-ethylcyclopentadienyl)Zr(CH₃)₂,
bis(n-ethylcyclopentadienyl)ZrCl₂,
bis(n-ethylcyclopentadienyl)Hf(CH₃)₂,
bis(n-ethylcyclopentadienyl)HfCl₂,
(n-ethylcyclopentadienyl,pentamethylcyclopentadienyl)ZrCl₂,
(n-ethylcyclopentadienyl,pentamethylcyclopentadienyl)Zr(CH₃)₂,
(n-ethylcyclopentadienyl,pentamethylcyclopentadienyl)HfCl₂,
(n-ethylcyclopentadienyl, pentamethylcyclopentadienyl)Hf(CH₃)₂,
bis(n-propylcyclopentadienyl)Zr(CH₃)₂,
bis(n-propylcyclopentadienyl)ZrCl₂,
bis(n-propylcyclopentadienyl)Hf(CH₃)₂,
bis(n-propylcyclopentadienyl)HfCl₂,
(n-propylcyclopentadienyl,pentamethylcyclopentadienyl)ZrCl₂,
(n-propylcyclopentadienyl,pentamethylcyclopentadienyl)Zr(CH₃)₂,
(n-propylcyclopentadienyl,pentamethylcyclopentadienyl)HfCl₂,
(n-propylcyclopentadienyl,pentamethylcyclopentadienyl)Hf(CH₃)₂,
bis(n-butylcyclopentadienyl)Zr(CH₃)₂,
bis(n-butylcyclopentadienyl)ZrCl₂,
bis(n-butylcyclopentadienyl)Hf(CH₃)₂,
bis(n-butylcyclopentadienyl)HfCl₂,
(n-butylcyclopentadienyl,pentamethylcyclopentadienyl)ZrCl₂,
(n-butylcyclopentadienyl,pentamethylcyclopentadienyl)Zr(CH₃)₂,
(n-butylcyclopentadienyl,pentamethylcyclopentadienyl)HfCl₂,
(n-butylcyclopentadienyl,pentamethylcyclopentadienyl)Hf(CH₃)₂,
or combinations thereof.

In yet other embodiments, the primary catalyst can be a bridged metallocene catalyst, such as in accordance with those described in one or more of U.S. Pat. Nos. 5,314,973; 6,255,426 (esp. at col. 2, line 61 to col. 3, line 17 therein, which description is incorporated herein by reference) and U.S. Pat. No. 5,763,543 (esp. at col. 2, line 42 to col. 4, line 22, which description is incorporated herein by reference). Particular examples include bridged bis-indenyl catalysts, such as bridged bis-indenyl zirconocenes or bridged bis-indenyl hafnocenes, particularly those in which each indenyl ligand is unsubstituted (e.g., is a tetrahydroindenyl ligand), and wherein the bridge is C₁-C₁₀ alkyl or R₁R₂Si, wherein R₁ and R₂ are each independently selected from methyl, ethyl, propyl, butyl, and pentyl. Examples of such bridged bis-indenyl hafnocenes and zirconocenes can include (CH₃)₂Si(4,5,6,7-tetrahydroindenyl)₂Zr(CH₃)₂, (CH₃)₂Si(4,5,6,7-tetrahydroindenyl)₂ZrCl₂, (CH₂CH₃)₂Si(4,5,6,7-tetrahydroindenyl)₂Zr(CH₃)₂, (CH₂CH₃)₂Si(4,5,6,7-tetrahydroindenyl)₂ZrCl₂, ((CH₃)₂Si)₂(4,5,6,7-tetrahydroindenyl)₂Zr(CH₃)₂, ((CH₃)₂Si)₂(4,5,6,7-tetrahydroindenyl)₂ZrCl₂, (CH₃)₂Si(4,5,6,7-tetrahydroindenyl)₂Hf(CH₃)₂, (CH₃)₂Si(4,5,6,7-tetrahydroindenyl)₂HfCl₂, (CH₂CH₃)₂Si(4,5,6,7-tetrahydroindenyl)₂Hf(CH₃)₂, (CH₂CH₃)₂Si(4,5,6,7-tetrahydroindenyl)₂HfCl₂, ((CH₃)₂Si)₂(4,5,6,7-tetrahydroindenyl)₂Hf(CH₃)₂, ((CH₃)₂Si)₂(4,5,6,7-tetrahydroindenyl)₂HfCl₂, or combinations thereof.

Although the catalyst compounds may be written or shown with methyl-, chloro-, or phenyl-leaving groups attached to the central metal, it can be understood that these groups may be different. For example, each of these ligands may independently be a benzyl group (Bn), a methyl group (Me), a chloro group (CI), a fluoro group (F), or any number of other groups, including organic groups, or heteroatom groups. Further, these ligands will change during the reaction, as a pre-catalyst is converted to the active catalyst for the reaction.

### Second Catalysts (e.g., “Trim” Catalysts)

A second catalyst of the present disclosure includes a second catalyst that is supported onto a support along with the first catalyst to form a dual catalyst system. The second catalyst can be supported and the dual catalyst system can be isolated. Alternatively, the second catalyst can be supported as a “trim” catalyst onto supported first catalyst in line on its way to the reactor. The dual catalyst system (e.g., also with activator) is introduced into a reactor (e.g., gas phase reactor).

In some embodiments, a second catalyst is represented by Formula (III):

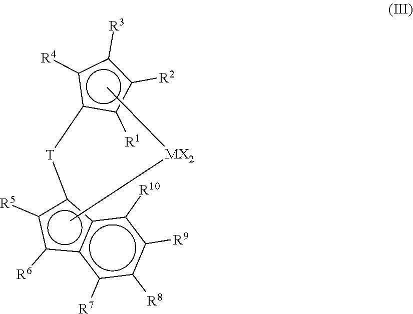

wherein:
M is a group 4 metal, such as titanium (Ti), zirconium (Zr), or hafnium (Hf);
each of R¹, R², R³, R⁴, R⁵, R⁶, R⁷, R⁸, R⁹, and R¹⁰ is independently hydrogen, substituted or unsubstituted hydrocarbyl, a substituted or unsubstituted heteroatom, or a substituted or unsubstituted heteroatom-containing group; optionally, one or more of R⁵ and R⁶, R⁷ and R⁸, R⁸ and R⁹, and R⁹ and R¹⁰ can be joined to form a substituted or unsubstituted completely saturated ring or a substituted or unsubstituted aromatic ring, and furthermore at least one of R⁵ and R⁶ is independently a substituted or unsubstituted aryl group or a substituted or unsubstituted heteroaryl group;
T represents the formula R^{a}₂J, (R^{a})₄J₂, or (R^{a})₆J₃ wherein each J is independently C, Si, or Ge, and each R^{a} is independently hydrogen, halide, a substituted or unsubstituted C₁ to C₄₀ hydrocarbyl, and wherein two R^{a} optionally can be joined to form a substituted or unsubstituted cyclic structure including a substituted or unsubstituted completely saturated ring, or a substituted or unsubstituted partially saturated ring (preferably, such ring structure has from 2-10 carbon atoms in addition to the J atom, and also the ring structure is preferably saturated); and
each X is independently a halide, a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene;
wherein at least one of R⁵ or R⁶ is independently a substituted or unsubstituted aryl group or a substituted or unsubstituted heteroaryl group.

In some embodiments, at least one of R⁵ or R⁶ is hydrogen and the other of R⁵ or R⁶ is independently a substituted or unsubstituted aryl group or a substituted or unsubstituted heteroaryl group. The aryl or heteroaryl group can be represented by the formula:

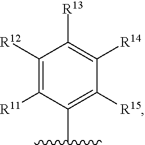

wherein each of R¹¹, R¹², R¹³, R¹⁴, and R¹⁵ is independently hydrogen, hydrocarbyl, a heteroatom, or heteroatom-containing group, or one or more of R¹¹ and R¹², R¹² and R¹³, R¹³ and R¹⁴, and R¹⁴ and R¹⁵ are joined to form a completely saturated, partially saturated, or aromatic ring. In some embodiments, each of R¹¹, R¹², R¹³, R¹⁴, and R¹⁵ is independently hydrogen or C₁-C₁₀ alkyl (such as methyl, ethyl, propyl, butyl, pentyl, hexyl, heptyl, octyl, nonyl, or decyl). In some embodiments, each of R¹¹, R¹², R¹³, R¹⁴, and R¹⁵ is hydrogen.

In some embodiments, each of R¹, R², R³, and R⁴ of Formula (III) is independently hydrogen or C₁-C₁₀ alkyl (such as methyl, ethyl, propyl, butyl, pentyl, hexyl, heptyl, octyl, nonyl, or decyl). In some embodiments, each of R¹, R², R³, and R⁴ is independently methyl, ethyl, or propyl. In some embodiments, each of R¹, R², R³, and R⁴ is methyl.

In some embodiments, each of R⁷, R⁸, R⁹, and R¹⁰ of Formula (III) is independently hydrogen or C₁-C₁₀ alkyl (such as methyl, ethyl, propyl, butyl, pentyl, hexyl, heptyl, octyl, nonyl, or decyl). In some embodiments, each of R⁷, R⁸, R⁹, and R¹⁰ is hydrogen.

In some embodiments of Formula (III), T is represented by the formula R^{a}₂J, (R^{a})₄J₂, or (R^{a})₆J₃ where J is C, Si, or Ge, and each R^{a} is independently hydrogen or C₁ to C₂₀ hydrocarbyl. In some embodiments, two R^{a} can form a cyclic structure including unsubstituted completely saturated, partially saturated, or aromatic ring. In some embodiments, T is selected from CH₂, CH₂CH₂, C(CH₃)₂, CPh₂, SiMe₂, SiEt₂, SiMeEt, SiPr₂, SiBu₂, SiPh₂, SiMePh, Si(CH₂)₃, Si(CH₂)₄, or Si(CH₂)₅. In some embodiments, T is SiMe₂, SiEt₂, SiPr₂, SiBu₂, or, more preferably, T is a ring structure such as Si(CH₂)₃ (silacyclobutyl), Si(CH₂)₄ (silacyclopentyl), or Si(CH₂)₅ (silacyclohexyl).

In some embodiments, each of R¹, R², R³, R⁴, R⁵, R⁶, R⁷, R⁸, R⁹, and R¹⁰ (and R¹¹, R¹², R¹³, R¹⁴, and R¹⁵) of Formula (III) is independently hydrogen, hydrocarbyl, silylcarbyl, alkoxyl, halide, or siloxyl.

In some embodiments of Formula (III), M is a group 4 metal, such as titanium (Ti), zirconium (Zr), or hafnium (Hf). In some embodiments, M is Zr or Hf. In some embodiments, each X is independently a halide, such as chloro. In yet other embodiments, each X is independently a C₁-C₄ alkyl, such as methyl. In some embodiments, each X is independently selected from substituted or unsubstituted hydrocarbyl, a heteroatom or substituted or unsubstituted heteroatom-containing group, such is methyl, benzyl, trimethylsilyl, methyl (trimethylsilyl), neopentyl, ethyl, propyl, butyl, phenyl, hydrido, chloro, fluoro, bromo, iodo, trifluoromethanesulfonate, dimethylamido, diethylamido, dipropylamido, and diisopropylamido.

In some embodiments of Formula (III), (1) Mis Zr or Hf, (2) X is C₁-C₅ alkyl, (3) T is Si(CH₂)₃, Si(CH₂)₄, or Si(CH₂)₅, (4) R⁵, R⁷, R⁸, R⁹, and R¹⁰ is independently hydrogen or substituted or unsubstituted C₁-C₁₀ alkyl, (5) R¹, R², R³, and R⁴ is independently methyl, ethyl, or propyl, and (6) R⁶ is substituted or unsubstituted aryl or substituted or unsubstituted heteroaryl. In some embodiments, R⁶ is an aryl group represented by the formula:

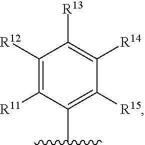

wherein each of R¹¹, R¹², R¹³, R¹⁴, and R¹⁵ is independently hydrogen, hydrocarbyl, a heteroatom, or heteroatom-containing group, or one or more of R¹¹ and R¹², R¹² and R¹³, R¹³ and R¹⁴, and R¹⁴ and R¹⁵ are joined to form a completely saturated, partially saturated, or aromatic ring. In some embodiments, each of R¹¹, R¹², R¹³, R¹⁴, and R¹⁵ is independently hydrogen or C₁-C₁₀ alkyl (such as methyl, ethyl, propyl, butyl, pentyl, hexyl, heptyl, octyl, nonyl, or decyl). In some embodiments, each of R¹¹, R¹², R¹³, R¹⁴, and R¹⁵ is hydrogen.

In some embodiments of Formula (III), the catalyst is selected from:

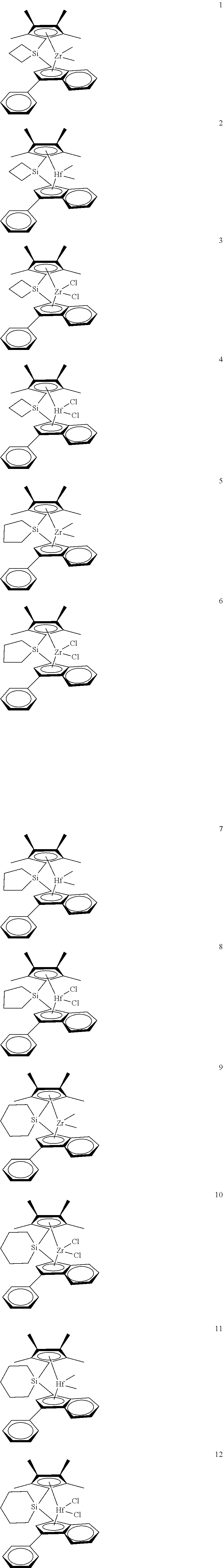

In some embodiments, a second catalyst is represented by Formula (IV):

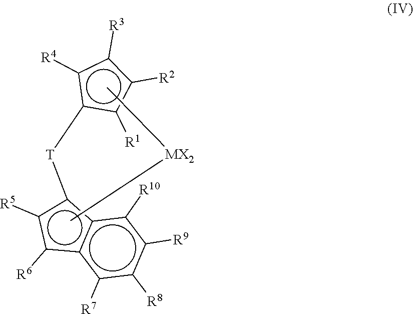

wherein:
M is a group 4 metal, such as titanium (Ti), zirconium (Zr), or hafnium (Hf);
each of R¹, R², R³, R⁴, R⁵, R⁶, R⁷, R⁸, R⁹, and R¹⁰ is independently hydrogen, substituted or unsubstituted hydrocarbyl, a substituted or unsubstituted heteroatom, or a substituted or unsubstituted heteroatom-containing group, or one or more of R⁵ and R⁶, R⁷ and R⁸, R⁸ and R⁹, and R⁹ and R¹⁰ are joined to form a substituted or unsubstituted completely saturated ring or a substituted or unsubstituted aromatic ring;
T represents the formula R^{a}₂J, (R^{a})₄J₂, or (R^{a})₆J₃ wherein each J is independently C, Si, or Ge, and each R^{a} is independently hydrogen, halide, a substituted or unsubstituted C₁ to C₄₀ hydrocarbyl, or two R^{a} can form a substituted or unsubstituted cyclic structure including a substituted or unsubstituted completely saturated ring, a substituted or unsubstituted partially saturated ring, or a substituted or unsubstituted aromatic ring; and
each X is independently a halide, a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene;
wherein at least one of (1) R⁷ and R⁸, (2) R⁸ and R⁹, or (3) R⁹ and R¹⁰ are joined to form a substituted or unsubstituted completely saturated ring fused to the indenyl ring shown in Formula (IV).

In some embodiments, each of R⁷, R⁸, R⁹, and R¹⁰ of Formula (IV) is independently hydrogen or C₁-C₁₀ alkyl (such as methyl, ethyl, propyl, butyl, pentyl, hexyl, heptyl, octyl, nonyl, or decyl), wherein at least one of (1) R⁷ and R⁸, (2) R⁸ and R⁹, or (3) R⁹ and R¹⁰ are joined to form a substituted or unsubstituted completely saturated ring fused to the indenyl ring shown in Formula (IV).

In some embodiments, at least one of (1) R⁷ and R⁸, (2) R⁸ and R⁹, or (3) R⁹ and R¹⁰ are joined to form a substituted or unsubstituted completely saturated ring fused to the indenyl ring shown in Formula (IV). In some embodiments, R⁷ and R⁸ are joined to form a substituted or unsubstituted saturated C₄ ring, a substituted or unsubstituted saturated C₅ ring, a substituted or unsubstituted saturated C₆ ring, or a substituted or unsubstituted saturated C₇ ring, where the C₄ ring, C₅ ring, C⁶ ring, or C₇ ring is fused to the indenyl ring shown in Formula (IV). In some embodiments, R⁸ and R⁹ are joined to form a substituted or unsubstituted saturated C₄ ring, a substituted or unsubstituted saturated C₅ ring, a substituted or unsubstituted saturated C₆ ring, or a substituted or unsubstituted saturated C₇ ring, where the C₄ ring, C₅ ring, C₆ ring, or C₇ ring is fused to the indenyl ring shown in Formula (IV). In some embodiments, R⁹ and R¹⁰ are joined to form a substituted or unsubstituted saturated C₄ ring, a substituted or unsubstituted saturated C₅ ring, a substituted or unsubstituted saturated C₆ ring, or a substituted or unsubstituted saturated C₇ ring, where the C₄ ring, C₅ ring, C₆ ring, or C₇ ring is fused to the indenyl ring shown in Formula (IV).

In some embodiments, each of R¹, R², R³, and R⁴ of Formula (IV) is independently hydrogen or C₁-C₁₀ alkyl (such as methyl, ethyl, propyl, butyl, pentyl, hexyl, heptyl, octyl, nonyl, or decyl). In some embodiments, each of R¹, R², R³, and R⁴ is independently methyl, ethyl, or propyl. In some embodiments, each of R¹, R², R³, and R⁴ is methyl.

In some embodiments of Formula (IV), T is represented by the formula R^{a}₂J, (R^{a})₄J₂, or (R^{a})₆J₃ where J is C, Si, or Ge, and each R^{a} is independently hydrogen or C₁ to C₂₀ hydrocarbyl. In some embodiments, two R^{a} can form a cyclic structure including unsubstituted completely saturated, partially saturated, or aromatic ring. In some embodiments, T is selected from CH₂, CH₂CH₂, C(CH₃)₂, CPh₂, SiMe₂, SiEt₂, SiPh₂, SiMePh, SiEtPh, SiMeEt, Si(CH₂)₃, Si(CH₂)₄, or Si(CH₂)₅. In some embodiments, Tis SiMe₂, SiEt₂, or SiMeEt.

In some embodiments, one or more of R¹, R², R³, R⁴, R⁵, R⁶, R⁷, R⁸, R⁹, and R¹⁰ of Formula (IV) is independently hydrogen, hydrocarbyl, silylcarbyl, alkoxyl, halide, or siloxyl.

In some embodiments of Formula (IV), M is a group 4 metal, such as titanium (Ti), zirconium (Zr), or hafnium (Hf). In some embodiments, M is Zr or Hf. In some embodiments, each X is independently a halide, such as chloro. In yet other embodiments, each X is independently a C₁-C₄ alkyl, such as methyl. In some embodiments, each X is independently selected from substituted or unsubstituted hydrocarbyl, a heteroatom or substituted or unsubstituted heteroatom-containing group, such as methyl, benzyl, trimethylsilyl, methyl (trimethylsilyl), neopentyl, ethyl, propyl, butyl, phenyl, hydrido, chloro, fluoro, bromo, iodo, trifluoromethanesulfonate, dimethylamido, diethylamido, dipropylamido, and diisopropylamido.

In some embodiments of Formula (IV), (1) Mis Zr or Hf, (2) X is C₁-C₅ alkyl, (3) Tis Si(CH₂)₃, Si(CH₂)₄, or Si(CH₂)₅, (4) R⁵, R⁶, R⁷, R⁸, R⁹, and R¹⁰ is independently hydrogen or substituted or unsubstituted C₁-C₁₀ alkyl, (5) at least one of R⁷ and R⁸, R⁸ and R⁹, or R⁹ and R¹⁰ are joined to form a substituted or unsubstituted completely saturated ring fused to the indenyl ring shown in Formula (IV), and (6) R¹, R², R³, and R⁴ is independently methyl, ethyl, or propyl.

In some embodiments of Formula (IV), the catalyst is selected from:

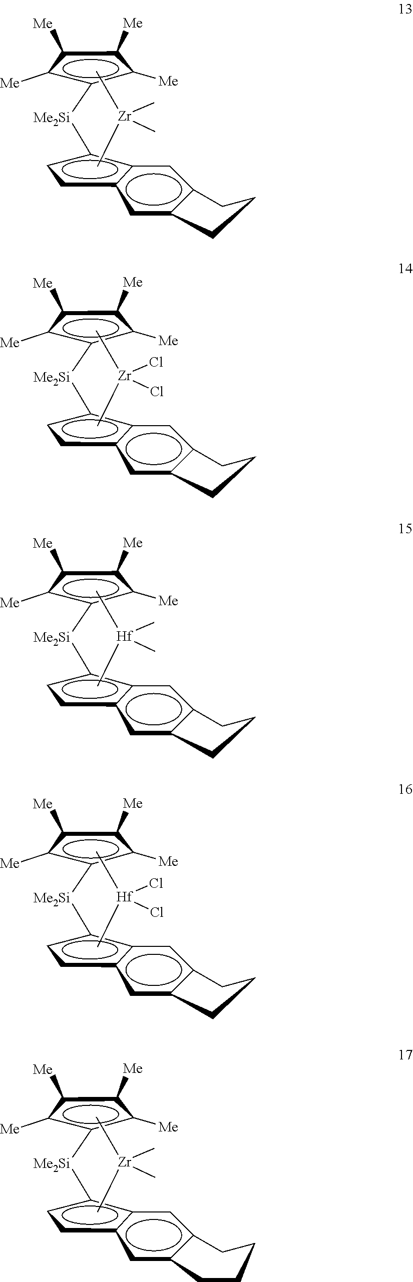

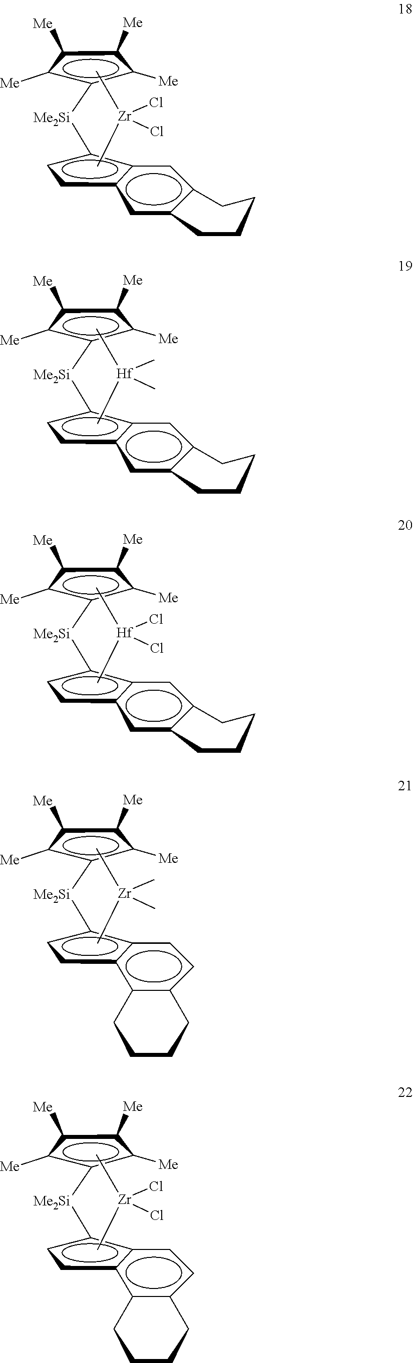

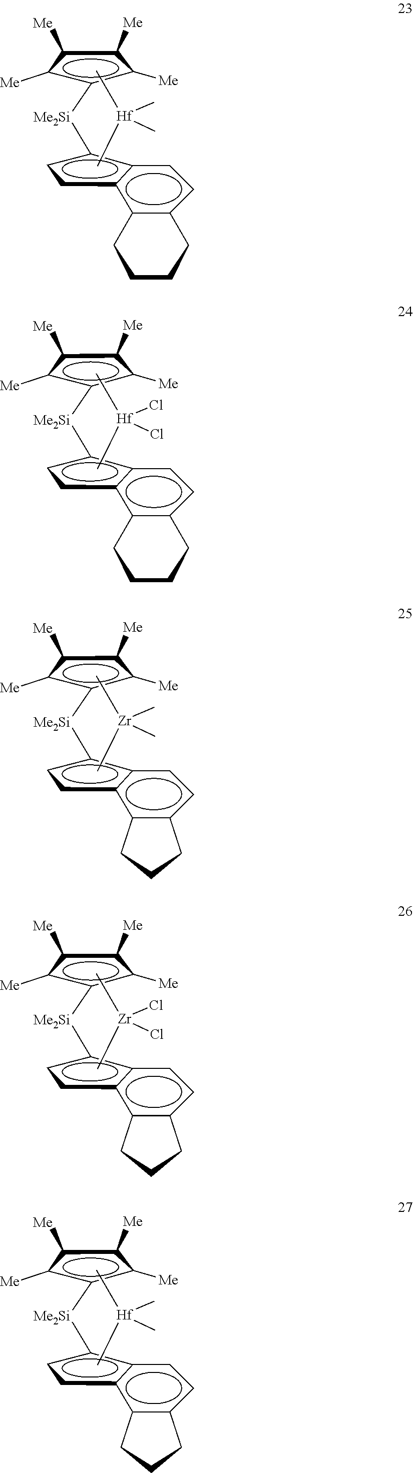

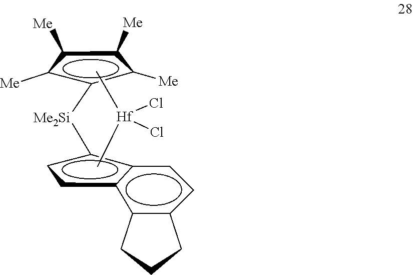

### Activators

The terms “cocatalyst” and “activator” are used herein interchangeably.

The catalyst systems described herein may include catalyst compound(s) as described above and an activator such as alumoxane or a non-coordinating anion and may be formed by combining the catalyst compounds described herein with activators in any manner known from the literature including combining them with supports, such as silica. The catalyst systems may also be added to or generated in solution polymerization or bulk polymerization (in the monomer).

Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, may include alumoxanes, aluminum alkyls, ionizing activators, which may be neutral or ionic, and conventional-type cocatalysts. Suitable activators may include alumoxane compounds, modified alumoxane compounds, and ionizing anion precursor compounds that abstract a reactive, σ-bound, metal ligand making the metal compound cationic and providing a charge-balancing non-coordinating or weakly coordinating anion, e.g., a non-coordinating anion.

In at least one embodiment, the catalyst system includes an activator, a catalyst compound of Formula (I), Formula (II), Formula (III), and/or Formula (IV), and a support.

### Alumoxane Activators

Alumoxane activators are utilized as activators in the catalyst systems described herein. Alumoxanes are generally oligomeric compounds containing —Al(R^{a}′″)—O— sub-units, where R^{a}′″ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, such as when the abstractable ligand is an alkyl, halide, alkoxide or amide. Mixtures of different alumoxanes and modified alumoxanes may also be used. It may be suitable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, as described in U.S. Pat. No. 5,041,584, which is incorporated by reference herein). Another useful alumoxane is solid polymethylaluminoxane as described in U.S. Pat. Nos. 9,340,630, 8,404,880, and 8,975,209, which are incorporated by reference herein.

When the activator is an alumoxane (modified or unmodified), and in at least one embodiment, an amount of activator at up to a 5,000-fold molar excess Al/M over the catalyst compound (per metal catalytic site) may be used. The minimum activator-to-catalyst-compound may be a 1:1 molar ratio. Alternate ranges may include about 1:1 to about 500:1, alternately about 1:1 to about 200:1, alternately about 1:1 to about 100:1, or alternately about 1:1 to about 50:1.

In an alternate embodiment, little or no alumoxane is used in the polymerization processes described herein. For example, alumoxane can be present at zero mol %, alternately the alumoxane can be present at a molar ratio of aluminum to catalyst compound transition metal less than 500:1, such as less than 300:1, such as less than 100:1, such as less than 1:1.

### Ionizing/Non-Coordinating Anion Activators

The term “non-coordinating anion” (NCA) means an anion which either does not coordinate to a cation or which is only weakly coordinated to a cation thereby remaining sufficiently labile to be displaced by a Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization. Suitable ionizing activators may include an NCA, such as a compatible NCA.

It is within the scope of the present disclosure to use an ionizing activator, neutral or ionic. It is also within the scope of the present disclosure to use neutral or ionic activators alone or in combination with alumoxane or modified alumoxane activators. For descriptions of some suitable activators and activator combinations, as well as relative amounts of activators and catalyst compounds, and optional chain transfer agents for use in conjunction with these catalyst compounds, please see U.S. Pat. Nos. 8,658,556 and 6,211,105, incorporated by reference herein; as well as U.S. Patent Publication 2021/0179650, and in particular Paragraphs [0084]-[0135] of WIPO Patent Publication No. WO2021/257264, which description is incorporated by reference herein (including the various descriptions that are incorporated by reference therein, such as WO2004/026921 page 72, paragraph to page 81, paragraph and WO2004/046214 page 72, paragraph to page 74, paragraph [00178])

Furthermore, a catalyst system of the present disclosure may include a metal hydrocarbenyl chain transfer agent represented by the formula:

Al(R′)₃₋ᵥ(R″)ᵥ

where each R′ can be independently a C₁-C₃₀ hydrocarbyl group, and or each R″, can be independently a C₄-C₂₀ hydrocarbenyl group having an end-vinyl group; and v can be from 0.1 to 3.

### Support Materials

In embodiments herein, the catalyst system may include an inert support material. The support material can be a porous support material, for example, talc, and inorganic oxides. Other support materials include zeolites, clays, organoclays, or another organic or inorganic support material, or mixtures thereof.

The support material can be an inorganic oxide. The inorganic oxide can be in a finely divided form. Suitable inorganic oxide materials for use in catalyst systems herein may include groups 2, 4, 13, and 14 metal oxides, such as silica, alumina, and mixtures thereof. Other inorganic oxides that may be employed either alone or in combination with the silica, or alumina can be magnesia, titania, zirconia. Other suitable support materials, however, can be employed, for example, finely divided functionalized polyolefins, such as finely divided polyethylene. Examples of suitable supports may include magnesia, titania, zirconia, montmorillonite, phyllosilicate, zeolites, talc, clays. Also, combinations of these support materials may be used, for example, silica-chromium, silica-alumina, silica-titania. In at least one embodiment, the support material is selected from Al₂O₃, ZrO₂, SiO₂, SiO₂/Al₂O₃, SiO₂/TiO₂, silica clay, silicon oxide/clay, or mixtures thereof.

The support material, such as an inorganic oxide, can have a surface area of about 10 m²/g to about 700 m²/g, pore volume of about 0.1 cm³/g to about 4.0 cm³/g and average particle size of about 5 μm to about 500 μm. The surface area of the support material can be of about 50 m²/g to about 500 m²/g, pore volume of about 0.5 cm³/g to about 3.5 cm³/g and average particle size of about 10 μm to about 200 μm. For example, the surface area of the support material can be about 100 m²/g to about 400 m²/g, pore volume of about 0.8 cm³/g to about 3.0 cm³/g and average particle size can be about 5 μm to about 100 μm. The average pore size of the support material useful in the present disclosure can be of about 10 Å to about 1000 Å, such as about 50 Å to about 500 Å, and such as about 75 Å to about 350 Å. In at least one embodiment, the support material is a high surface area, amorphous silica (surface area=300 m²/gm; pore volume of 1.65 cm³/gm). For example, suitable silicas can be the silicas marketed under the tradenames of DAVISON™ 952 or DAVISON™ 955 by the Davison Chemical Division of W.R. Grace and Company. In other embodiments, DAVISON™ 948 is used. Alternatively, a silica can be ES-70™ silica (PQ Corporation, Malvern, Pennsylvania) that has been calcined, for example (such as at 875° C.).

The support material should be dry, that is, free or substantially free of absorbed water. Drying of the support material can be effected by heating or calcining at about 100° C. to about 1000° C., such as at least about 600° C. When the support material is silica, it is heated to at least 200° C., such as about 200° C. to about 850° C., and such as at about 600° C.; and for a time of about 1 minute to about 100 hours, about 12 hours to about 72 hours, or about 24 hours to about 60 hours. The calcined support material must have at least some reactive hydroxyl (OH) groups to produce supported catalyst systems of the present disclosure. The calcined support material is then contacted with at least one polymerization catalyst including at least one catalyst compound and an activator.

The support material, having reactive surface groups, such as hydroxyl groups, is slurried in a non-polar diluent and the resulting slurry is contacted with a solution of a catalyst compound and an activator. In at least one embodiment, the slurry of the support material is first contacted with the activator for a period of time of about 0.5 h to about 24 h, about 2 h to about 16 h, or about 4 h to about 8 h. The solution of the catalyst compound is then contacted with the isolated support/activator. In at least one embodiment, the supported catalyst system is generated in situ. In alternate embodiments, the slurry of the support material is first contacted with the catalyst compound for a period of time of about 0.5 h to about 24 h, about 2 h to about 16 h, or about 4 h to about 8 h. The slurry of the supported catalyst compound is then contacted with the activator solution.

The mixture of the catalyst(s), activator(s) and support is heated about 0° C. to about 70° C., such as about 23° C. to about 60° C., such as at room temperature. Contact times can be about 0.5 hours to about 24 hours, such as about 2 hours to about 16 hours, or about 4 hours to about 8 hours.

Suitable non-polar diluents are materials in which all of the reactants used herein, e.g., the activator and the catalyst compound, are at least partially soluble and which are liquid at polymerization temperatures. Non-polar diluents can be alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

In at least one embodiment, the support material is a supported methylalumoxane (SMAO), which is an MAO activator treated with silica (e.g., ES-70-875 silica).

### Polyethylene Copolymers

The present disclosure provides polyethylene copolymers having a combination of low density, high melt index, long chain branching, and bimodal composition distribution. In addition, the polyethylene copolymers and films thereof can be formed by commercially desirable polymerizations and extrusions of the polyethylene copolymers.

Thus, polyethylene copolymers of various embodiments herein can exhibit one or more of the following properties:
Density of about 0.914 to about 0.925 g/cm³, such as from a low of any one of 0.914, 0.915, 0.916, 0.917, 0.918, 0.919, or 0.92 g/cm³ to a high of any one of 0.925, 0.924, 0.923, 0.922, 0.921, 0.920, or 0.919 g/cm³, such as about 0.915 g/cm³ to about 0.920 g/cm³, alternatively about 0.918 g/cm³ to about 0.922 g/cm³, with combinations from any low to any high contemplated (provided the high end is greater than the low end), e.g., about 0.916 to about 0.921 g/cm³
   Melt Index (MI, also referred to as I₂ or I_{2.16} in recognition of the 2.16 kg loading used in the test) of about 0.1 or greater g/10 min (ASTM D1238, 190° C., 2.16 kg), such as from a low of any one of 0.1, 0.2, 0.3, 0.4, 0.5, 0.6, 0.7, 0.8, 0.9, 1, 1.1, 1.2, 1.3, 1.4, or 1.5 g/10 min to a high end of any one of 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 4, or 5 g/10 min, with ranges from any low end to any high end contemplated herein (provided the high end is greater than the low end), such as about 0.1 to about 1 g/10 min, such as about 0.3 to about 0.8 g/10 min, such as about 0.4 to about 0.6 g/10 min.

The polyethylene copolymer may be the polymerization product of an ethylene monomer and one or more olefin comonomers, such as alpha-olefin comonomers. Alpha-olefin comonomers can have 3 to 12 carbon atoms, or from 4 to 10 carbon atoms, or from 4 to 8 carbon atoms. Olefin comonomers can be selected from the group consisting of propylene, 1-butene, 1-pentene, 1-hexene, 1-heptene, 1-octene, 4-methylpent-1-ene, 1-nonene, 1-decene, 1-undecene, 1-dodecene, 1-hexadecene, and the like, and any combination thereof, such as 1-butene, 1-hexene, and/or 1-octene. In some embodiments, a polyene is used as a comonomer. In some embodiments, the polyene is selected from the group consisting of 1,3-hexadiene, 1,4-hexadiene, cyclopentadiene, dicyclopentadiene, 4-vinylcyclohex-1-ene, methyloctadiene, 1-methyl-1,6-octadiene, 7-methyl-1,6-octadiene, 1,5-cyclooctadiene, norbornadiene, ethylidene norbornene, 5-vinylidene-2-norbornene, 5-vinyl-2-norbornene, and olefins formed in situ in the polymerization medium. In some embodiments, comonomers are selected from the group consisting of isoprene, styrene, butadiene, isobutylene, chloroprene, acrylonitrile, and cyclic olefins. In some embodiments, combinations of the olefin comonomers are utilized. In some embodiments, the olefin comonomer is selected from the group consisting of 1-butene and 1-hexene. The olefin comonomer content of the polyethylene copolymer can range from a low of about 0.1, 5, 5.5, 6, 6.5, 7, 7.5, 8, or 8.5 wt % to a high of about 20, 15, 13, 12.5, 12, 11.5, 11, 10.5, 10, 9.5, or 9 wt %, on the basis of total weight of monomers in the polyethylene copolymer. The balance of the polyethylene comonomer is made up of units derived from ethylene (e.g., from a low of about 80, 85, 88, 90, 91, 92, 92.5, 93, 93.5, or 94 wt % to a high of about 90, 91, 92, 92.5, 93, 93.5, 94, 94.5, 95, 95.5, 96, 97, 99, or 99.9 wt %). Ranges from any foregoing low end to any foregoing high end are contemplated herein (e.g., about 88 to about 93 wt %, such as about 91 to about 93 wt % ethylene-derived units and the balance olefin comonomer-derived content).

The polyethylene copolymers can also have a high load melt index (HLMI) (also referred to as I₂₁ or I_{21.6} in recognition of the 21.6 kg loading used in the test) within the range from a low of about 15, 20, 25, 30, 35, 40, 45, 50, or 55 g/10 min to a high of about 75, 70, 65, 60, 55, 50, 45, 40, 35, 30, or 25 g/10 min; with ranges from any of the foregoing lows to any of the foregoing highs contemplated herein (e.g., about 45 to about 70 g/10 min, such as about 50 to about 60 g/10 min, alternatively about 20 to about 30 g/10 min). The term “high load melt index” (“HLMI”), is the number of grams extruded in 10 minutes under the action of a standard load (21.6 kg) and is an inverse measure of viscosity. As provided herein, HLMI (121) is determined according to ASTM D1238 (190° C./21.6 kg) and is also sometimes referred to as I₂₁ or I_{21.6}.

The polyethylene copolymers can also have a melt index ratio (MIR, defined as the ratio of I_{21.6}/I_{2.16}) within the range from a low of any one of about 20, 25, 30, 35, 40, 45, 50, or 55 to a high of any one of about 75, 70, 65, 60, 55, 50, 45, or 40 with ranges from any of the foregoing lows to any of the foregoing highs contemplated herein (e.g., about 40 to about 50, alternatively about 50 to about 60).

The polyethylene copolymers can also have a molecular weight distribution (MWD) of about 2 to about 10. The MWD can range from a low of about 2, 2.5, 3, 3.5, 4, 4.2, 4.4, 4.5, 4.6, 4.8, 5, 5.1, 5.2, 5.3, 5.4, 5.5, or 6 to a high of about 3.5, 4, 4.5, 5, 5.1, 5.2, 5.3, 5.4, 5.5, 5.6, 5.7, 5.8, 5.9, 6, 6.5, 7, 7.1, 7.2, 7.3, 7.4, 7.5, 8.0, 8.5, 9.0, 9.5, or 10.0, with ranges from any foregoing low to any foregoing high contemplated, provided the high end of the range is greater than the low end. MWD is defined as the weight average molecular weight (Mw) divided by number-average molecular weight (Mn), and can be referred to as polydispersity index (PDI).

Weight-average molecular weight (Mw) of polyethylene copolymers of various embodiments (e.g., when the base catalyst is a bridged bis-indenyl hafnocene or zirconocene) may be within the range from about 70,000 to about 400,000 g/mol, such as about 75,000 to about 150,000 g/mol, such as about 90,000 to about 130,000 g/mol, such as about 100,000 to about 120,000 or 125,000 g/mol, alternatively (e.g., when the base catalyst is an unbridged bis-indenyl hafnocene or zirconocene) about 100,000 to about 300,000 g/mol, such as about 150,000 to about 250,000 g/mol, such as about 150,000 to about 210,000 g/mol, alternatively about 128,000 to about 150,000 g/mol, with ranges from any foregoing low end to any foregoing high end contemplated.

Number-average molecular weight (Mn) of polyethylene copolymers of various embodiments may be within the range from about 10,000 to about 45,000 g/mol, such as about 10,000 to about 30,000 g/mol, such as about 15,000 to about 25,000 g/mol, with ranges from any foregoing low end to any foregoing high end contemplated.

Z-average molecular weight (Mz) of polyethylene copolymers of various embodiments (e.g., when the base catalyst is a bridged bis-indenyl hafnocene or zirconocene) may be within the range from about 150,000 to about 400,000 g/mol, such as about 200,000 to about 350,000 g/mol, or about 200,000 to about 275,000 g/mol, such as about 220,000 to about 260,000 g/mol, alternatively (e.g., when the base catalyst is an unbridged bis-indenyl hafnocene or zirconocene) about 150,000 to about 1,000,000 g/mol, such as about 300,000 to about 900,000 g/mol, or about 300,000 to about 400,000 g/mol, alternatively about 400,000 g/mol to about 500,000 g/mol, alternatively about 500,000 g/mol to about 600,000 g/mol, alternatively about 600,000 g/mol to about 700,000 g/mol, alternatively about 700,000 g/mol to about 800,000 g/mol, alternatively about 800,000 g/mol to about 900,000 g/mol, with ranges from any foregoing low end to any foregoing high end contemplated.

Polyethylene copolymers of various embodiments may also exhibit long-chain branching. As noted previously, this may be evidenced through, e.g., SAOS viscosity data (especially η_{0.01}/η₁₀₀) and/or MIR. Further, LCB or branching index (referred to herein as g′_{vis ave} or alternatively g′ᵥᵢₛ) could be less than 1, such as within the range from a low of about 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, or 0.86 to a high of any one of about 0.80, 0.85, 0.86, 0.87, 0.88, 0.89, 0.90, 0.91, 0.92, 0.93, or 0.94, with ranges from any foregoing low end to any foregoing high end contemplated, provided the high end is greater than the low end (e.g., 0.65 to 0.95, such as 0.72 to 0.87, or 0.82 to 0.92, or 0.86 to 0.92, etc.).

The distributions and the moments of molecular weight (Mw, Mn, Mw/Mn, etc.), and the branching index (g′vis) are determined by using a high temperature Gel Permeation Chromatography (Polymer Char GPC-IR) equipped with a multiple-channel band-filter based Infrared detector IR5, an 18-angle Wyatt Dawn Heleos light scattering detector and a 4-capillary viscometer with Wheatstone bridge configuration. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 ml/min and the nominal injection volume is 200 μL. The whole system including transfer lines, columns, and viscometer detector are contained in ovens maintained at 145° C. The polymer sample is weighed and sealed in a standard vial with 80-μL flow marker (Heptane) added to it. After loading the vial in the autosampler, polymer is automatically dissolved in the instrument with 8 ml added TCB solvent.

The polymer is dissolved at 160° C. with continuous shaking for about 2 hour. The concentration (c), at each point in the chromatogram is calculated from the baseline-subtracted IR5 broadband signal intensity (I), using the following equation: c=βI, where β is the mass constant. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10 million g/mol. The MW at each elution volume is calculated with the following equation:

$$log M = \frac{log ( {K}_{PS} / K )}{a + 1} + \frac{{a}_{PS} + 1}{a + 1} log {M}_{PS}$$

where the variables with subscript “PS” stand for polystyrene while those without a subscript are the test samples. In this method, α_{PS}=0.67 and K_{PS}=0.000175 while α and K are for ethylene-hexene copolymers as calculated from empirical equations (Sun, T. et al. Macromolecules 2001, 34, 6812), in which a=0.695 and K=0.000579 (1-0.75 Wt), where Wt is the weight fraction for hexene comonomer. It should be noted that the comonomer composition is determined by the ratio of the IR5 detector intensity corresponding to CH₂ and CH₃ channel calibrated with a series of PE and ethylene-hexene homo/copolymer standards whose nominal values are predetermined by NMR or FTIR. Here the concentrations are expressed in g/cm³, molecular weight is expressed in g/mol, and intrinsic viscosity (hence K in the Mark-Houwink equation) is expressed in dL/g.

The LS molecular weight (M) at each point in the chromatogram is determined by analyzing the LS output using the Zimm model for static light scattering

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and Ko is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm. For purposes of the present disclosure and the claims thereto (dn/dc)=0.1048 for ethylene-hexene copolymers.

When molecular weight values are referenced herein, it should be assumed that they are determined via light scattering (LS) techniques, unless stated otherwise.

Viscosity-average molecular weight (M_{V}): A high temperature Polymer Char viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the equation [η]=ηₛ/c, where c is concentration and is determined from the IR5 broadband channel output. The viscosity MW at each point is calculated as M=K_{PS}M^{α}^{_{PS}}⁺¹/[η], where α_{PS} is 0.67 and Kps is 0.000175. The average intrinsic viscosity [η]_{avg} of the sample is calculated by

$${[ η ]}_{avg} = \frac{\sum {{c}_{i} [ η ]}_{i}}{\sum {c}_{i}}$$

where the summations are over the chromatographic slices, i, between the integration limits.

The branching index (g′ᵥᵢₛ) can be calculated using the output of the GPC-IR5-LS-VIS method as follows. First, it is noted that g′ or g′vis can in general be considered the ratio of a polymer's intrinsic viscosity to that of a linear polymer of the same molecular weight and composition: g′=[η_{polymer}]/[η_{reference}], where [η_{polymer}] is the intrinsic viscosity of the polymer under investigation and [reference] is the intrinsic viscosity of a linear resin of the same composition with the same molecular weight. A polymer's relative intrinsic viscosity (g′) is therefore a measure of how much the polymer enhances its solution's viscosity relative to how much a linear polymer of the same molecular weight and composition enhances its solution's viscosity, under the same conditions of temperature and pressure.

Following this principle, the [η_{polymer}] value in the above simplified relationship may be taken as the weight-average intrinsic viscosity, [η]_{avg}, of the sample, which is calculated by:

$${[ η ]}_{a v g} = \frac{\sum {{c}_{i} [ η ]}_{i}}{\sum {c}_{i}}$$

where the summations are over the chromatographic slices, i, between the integration limits. The branching index g′ᵥᵢₛ is defined against the linear reference as

$${g}_{v i s}^{′} = \frac{{[ η ]}_{avg}}{K {M}_{v}^{α}} ,$$

where Mᵥ is the viscosity-average molecular weight based on molecular weights determined by LS analysis and the K and α are for the reference linear polymer; for purposes of the present disclosure, a and K are the same as described above for linear polyethylene polymers.

The branching index g′vis may equivalently be referred to as g′_{vis ave} to reflect that it is an average value of g′ determined at each of multiple discrete concentration slices. For example, with reference to FIG. 1, one can see g′ for various polyethylene copolymers plotted as a function of LogM (log of molecular weight), implying a g′ value can be calculated for a given molecular weight population of polymer chains in the polyethylene copolymer composition. The above calculations provide the g′_{vis ave} as a weighted average of these multiple g′ values, and the g′_{vis ave} can be taken as a good relative indicator of the presence of long chain branching when comparing such value between two different copolymer compositions, with lower g′_{vis ave} indicating greater long chain branching.

### Broad Orthogonal Composition Distribution

“BOCD” refers to a Broad Orthogonal Composition Distribution in which the comonomer of a copolymer is incorporated predominantly in the high molecular weight chains or species of a polyolefin polymer or composition. The distribution of the short chain branches can be measured, for example, using Temperature Raising Elution Fractionation (TREF) in connection with a Light Scattering (LS) detector to determine the weight average molecular weight of the molecules eluted from the TREF column at a given temperature. The combination of TREF and LS (TREF-LS) yields information about the breadth of the composition distribution and whether the comonomer content increases, decreases, or is uniform across the chains of different molecular weights of polymer chains. BOCD has been described, for example, in U.S. Pat. Nos. 8,378,043, Col. 3, line 34, bridging Col. 4, line 19, and 8,476,392, line 43, bridging Col. 16, line 54.

The BOCD nature of the present polyethylene copolymers can be quantified in the composition distribution breadth index (CDBI). For instance, polyethylene copolymers described herein can have a low value of composition distribution breadth index (CBDI), in which the polyethylene copolymers may have a CBDI % within a range from a low of any one of about 40, 45, 50, 55, 60, 65, 70, 75, or 80% to a high of any one of about 99, 95, 90, 85, 80, 75, 70, 65, or 60%; with ranges from any of the foregoing lows to any of the foregoing highs contemplated herein (e.g., about 50% to about 85%, such as about 55% to about 75%, alternatively about 70% to about 85%, alternatively about 75% to about 85%). In some embodiments, polyethylene copolymers described herein can have a low value of composition distribution breadth index (CBDI), in which the polyethylene copolymers may have a CBDI % within a range from a low of any one of about 30, 35, 40, 45, 50, or 55% to a high of any one of about 70, 65, 60, 55, 50, or 45%; with ranges from any of the foregoing lows to any of the foregoing highs contemplated herein (e.g., about 35% to about 65%, such as about 40% to about 50%, alternatively about 50% to about 65%, such as about 50% to about 60%).

CDBI is defined as the weight percent of the copolymer molecules having a comonomer content within +/−50% of the median comonomer mol % value, as described at pp. 18-19 of WO 1993/003093 in conjunction with FIG. 17 therein. This means that for a copolymer having median comonomer mol % value (Cmed) of 8 mol % comonomer on a polymer chain, CDBI is the wt % of copolymer chains having comonomer mol % that is between (0.5×Cmed) and (1.5×Cmed). In this example, CDBI is the wt % of copolymer chains having comonomer mol % between (0.5×8) and (1.5×8), or comonomer content between 4 mol % and 12 mol %. WO 1993/003093 also describes the process for determining the weight fraction of polymer vs. composition curve (i.e., the composition distribution curve) using chromatography and C¹³ NMR, and determining the median comonomer composition Cmed therefrom, with reference to FIGS. 16 and 17 of that publication. The CDBI of a copolymer is readily determined utilizing a technique for isolating individual fractions of a sample of the copolymer. One such technique is generation of a solubility distribution curve using Temperature Rising Elution Fraction (TREF), as described in WO 1993003093 (which in turn references Wild, et al., J. Poly. Sci., Poly. Phys. Ed., vol. 20, p. 441 (1982) and U.S. Pat. No. 5,008,204 in this regard). All three of the foregoing publications are incorporated herein by reference.

The solubility distribution curve can be first generated for the copolymer using data acquired from TREF techniques (as described, e.g., in the just-referenced publications). This solubility distribution curve is a plot of the weight fraction of the copolymer that is solubilized as a function of temperature. This can be converted to a weight fraction versus composition distribution curve. For the purpose of simplifying the correlation of composition with elution temperature the weight fractions less than 15,000 can be ignored. These low weight fractions generally represent a trivial portion of the ethylene-based polymers disclosed herein.

Alternatively or additionally, the composition distribution can be characterized by the T₇₅-T₂₅ value, wherein T₂₅ is the temperature at which 25% of the eluted polymer is obtained and T₇₅ is the temperature at which 75% of the eluted polymer is obtained, both in a TREF experiment (and plotting of eluted polymer molecular weights vs. elution temperatures) as described in US2019/0119413 (especially in paragraphs [0055]-[0058] thereof, which description is incorporated by reference herein). A narrow composition distribution is reflected in a relatively small difference in the T₇₅-T₂₅ value, while a broad distribution is reflected in a relatively larger difference in the T₇₅-T₂₅ value, implying greater differences in crystallinity between fractions of the polymer composition. It is also noted that, in the event of discrepancies between the actual TREF procedure as described in US2019/0119413 vs. the TREF procedure as described in WO 1993003093, U.S. Pat. Nos. 5,382,630, and/or 5,008,204, the TREF procedure as described in US2019/0119413 should be used. (Note further that the curves generated ancillary to the TREF procedures-solubility distribution curve for CDBI, and eluted molecular weights vs elution temperature for T₇₅-T₂₅, may have appropriate differences in their generation and analysis for CDBI and T₇₅-T₂₅.) Finally, the TREF curve (eluted polymer molecular weights vs elution temperatures) generated in connection with T₇₅-T₂₅ measurements can be further processed as follows:
1. The solvent-only response of the instrument can be generated and subtracted from the TREF curve of the sample. The solvent-only response can be generated by running, typically before, the same method as used for the polymer sample, but without any polymer added to the sample vial; using the same solvent reservoir as for the polymer sample and without replenishing with fresh solvent; and within a reasonable proximity of time from the run for the polymer sample.
2. The temperature axis of the TREF curve can be appropriately shifted to correct for the delay in the IR signal caused by the column-to-detector volume. This volume can be obtained by first filling the injection-valve loop with a ~1 mg/ml solution of an HDPE resin; then loading the loop volume in the same location within the column where a sample is loaded for TREF analysis; then directly flowing, at a constant flow rate of 1 ml/min, the hot solution towards the detector using an isothermal method; and then measuring the time after injection for the HDPE probe's peak to appear in the IR signal. The delay volume (ml) is therefore equated to the time (min).

The curve can be baseline corrected and appropriate integration limits can be selected; and the curve can be normalized so that the area of the curve is 100 wt %.

A narrow distribution, as in some embodiments of the present polyethylene copolymers, is reflected in the relatively small difference in the T₇₅-T₂₅ value being less than 15° C., such as within the range from a low of any one of 1, 2, 3, 4, 5, 6, 7, 8, or 9° C. to a high of any one of 10, 11, 12, 13, 14, or 15° C., with ranges from any foregoing low to any foregoing high contemplated (e.g., about 1° C. to about 10° C., such as about 5° C. to about 8° C., alternatively about 7° C. to about 11° C.). In yet other embodiments, polyethylene copolymers of the present disclosure may exhibit bimodal composition distribution, such as BOCD (broad orthogonal composition distribution, meaning preferential incorporation of comonomer onto longer polymer chains as compared to shorter chains), and have relatively higher T₇₅-T₂₅ value such as 15° C. or greater, such as within the range from a low of any one of 15, 16, 17, or 18° C. to a high of any one of 21, 22, 23, 24, 25, 26, 27, 28, 29, 30, or 35° C., with ranges from any foregoing low to any foregoing high contemplated (e.g., about 15° C. to about 30° C., such as 18° C. to 28° C., alternatively about 18° C. to about 25° C., such as about 19° C. to about 22° C. or 23° C.).

### Blends and Additives

In some embodiments, the polyethylene copolymers can be formulated (e.g., blended) with one or more other polymer components. In some embodiments, those other polymer components are alpha-olefin polymers such as polypropylene or polyethylene homopolymer and copolymer compositions. In some embodiments, those other polyethylene polymers are selected from the group consisting of linear low density polyethylene, high density polyethylene, medium density polyethylene, low density polyethylene, and other differentiated polyethylenes.

In some embodiments, the formulated blends can contain additives, which are determined based upon the end use of the formulated blend. In some embodiments, the additives are selected from the group consisting of fillers, antioxidants, phosphites, anti-cling additives, tackifiers, ultraviolet stabilizers, heat stabilizers, antiblocking agents, release agents, antistatic agents, pigments, colorants, dyes, waxes, silica, processing aids, neutralizers, lubricants, surfactants, and nucleating agents. In some embodiments, additives are present in an amount from about 0.1 ppm to about 5 wt %.

Polyethylene copolymers of the present disclosure can be optionally blended with one or more processing aids to form a polyethylene blend. Because of the improved properties of polyethylene copolymers of the present disclosure, advantageously, such processing aids can be omitted even in blown films (e.g., films, and particularly blown films, of some embodiments may be free of or substantially free of polymer processing aids, and especially polymer processing aids comprising fluorine; where “substantially free” means free of any intentionally added components, but allowing for up to 100 ppm of such component(s) as impurities).

### Articles of Manufacture

The polyethylene copolymers of the present disclosure can be particularly suitable for making end-use articles of manufacture such as films (e.g., as may be formed by lamination, extrusion, coextrusion, casting, and/or blowing); as well as other articles of manufacture as may be formed, e.g., by rotomolding or injection molding. Polyethylene copolymers can be formed into articles of manufacture by cast film extrusion, blown film extrusion, rotational molding or injection molding processes. In some embodiments, the polyethylene copolymer can be used in a blend.

It has been discovered that polyethylene copolymers of the present disclosure can provide excellent shear thinning characteristics with little or no melt fracture of the extrudate at high die shear rates. Further, polyethylene copolymers of the present disclosure can provide films formed with reduced motor load and melt pressure due to improved flow behavior, as compared to other LLDPEs.

A polyethylene copolymer (or blend thereof) of the present disclosure can be useful in such forming operations as film, sheet, and fiber extrusion and co-extrusion as well as blow molding, injection molding, and rotary molding. Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, membranes, etc., in food-contact and non-food contact applications. For example, polyethylene copolymers of the present disclosure provide improved shrink wrap capability due to long chain branching properties. Fibers include melt spinning, solution spinning and melt blown fiber operations for use in woven or non-woven form to make filters, diaper fabrics, medical garments, geotextiles, etc. Extruded articles include medical tubing, wire and cable coatings, pipe, geomembranes, and pond liners. Molded articles include single and multi-layered constructions in the form of bottles, tanks, large hollow articles, rigid food containers and toys, etc.

The polyethylene copolymers (or blends thereof) may be formed into monolayer or multilayer films. These films may be formed by any of the conventional techniques including extrusion, co-extrusion, extrusion coating, lamination, blowing and casting. The film may be obtained by the flat film or tubular process which may be followed by orientation in a uniaxial direction or in two mutually perpendicular directions in the plane of the film. One or more of the layers of the film may be oriented in the transverse and/or longitudinal directions to the same or different extents. This orientation may occur before or after the individual layers are brought together. For example, a polyethylene copolymer (or blend thereof) layer can be extrusion coated or laminated onto an oriented polypropylene layer or the polyethylene copolymer (or blend thereof) and polypropylene can be coextruded together into a film then oriented. Likewise, oriented polypropylene could be laminated to oriented polyethylene copolymer (or blend thereof), or oriented polyethylene copolymer (or blend thereof) could be coated onto polypropylene then optionally the combination could be oriented even further.

Films include monolayer or multilayer films. Particular end use films include, for example, blown films, cast films, stretch films, stretch/cast films, stretch cling films, stretch handwrap films, machine stretch wrap, shrink films, shrink wrap films, greenhouse films, laminates, and laminate films. Exemplary films are prepared by any conventional technique known to those skilled in the art, such as for example, techniques utilized to prepare blown, extruded, and/or cast stretch and/or shrink films (including shrink-on-shrink applications).

In at least one embodiment, multilayer films (multiple-layer films) may be formed by any suitable method. The total thickness of multilayer films may vary based upon the application desired. A total film thickness of 5-100 μm, such as 10-50 μm, is suitable for most applications. Those skilled in the art will appreciate that the thickness of individual layers for multilayer films may be adjusted based on desired end-use performance, polymer(s) employed, equipment capability, and other factors. The materials forming each layer may be coextruded through a coextrusion feedblock and die assembly to yield a film with two or more layers adhered together but differing in composition. Coextrusion can be adapted for use in both cast film or blown film processes. Exemplary multilayer films have at least two, at least three, or at least four layers. In one embodiment the multilayer films are composed of five to ten layers.

In at least one embodiment, a film of the present disclosure has an averaged 1% Secant Modulus (M), at 23° C. according to a ASTM D882-18 of about 30,000 psi to about 40,000 psi, such as about 31,000 psi to about 40,000 psi, such as about 33,000 to about 38,000 psi, such as about 34,000 psi to about 36,000 psi.

A film of the present disclosure can have an Elmendorf Tear value, in accordance with ASTM D-1922. In at least one embodiment, a film has an Elmendorf Tear (MD) of at least 30 g/mil, such as at least 50 g/mil, such as about 60 g/mil to about 100 g/mil, such as about 80 g/mil to about 100 g/mil.

A film of the present disclosure can have a Dart Drop Impact (or Impact Failure or Dart F50 or Dart Drop Impact Strength (DIS)), reported in grams (g) or grams per mil (g/mil), in accordance with ASTM D-1709, method A. A film of the present disclosure can have a Dart Drop Impact of from about 5 g/mil to about 600 g/mil. In at least one embodiment, the film has a Dart Drop Impact of at least about 100 g/mil, such as at least about 120 g/mil, such as at least about 130 g/mil. For example, the Dart Drop Impact can be about 100 g/mil to about 200 g/mil, such as about 120 g/mil to about 170 g/mil, such as about 130 g/mil to about 160 g/mil.

Shrink of a film, reported as a percentage, can be measured by cutting circular specimens from a film using a 100 mm die. The samples can be marked in their respective directions, dusted with talc, and placed on a pre-heated, talc covered tile. The samples can then heated using a heat gun (e.g., model HG-501A) for approximately 10 to 45 seconds, or until any dimensional change ceases. Values are the average of three specimens. A negative shrinkage number indicates expansion of a dimension after heating when compared to its pre-heating dimension. A film of the present disclosure can have a % shrink (Machine Direction) of about 40% to about 90%, such as about 60% to about 80%, such as about 65% to about 75%. A film of the present disclosure can have a % shrink (Transverse Direction) of about about 0% to about 5%, such as about 0.5% to about 4%, such as about 1% to about 3%.

In certain embodiments, the film may have a puncture energy at break, in accordance with a modified ASTM D5748 (ASTM probe used with two 0.25 mil HDPE slip sheets. Machine Model: United SFM-1. Testing speed: 10 in/min), of at least about 25 in-lbs/mil, such as at least about 30 in-lbs/mil, such as at least about 35 in-lbs/mil, such as about 25 in-lbs/mil to about 40 in-lbs/mil, such as about 30 in-lbs/mil to about 40 in-lbs/mil, such as about 30 in-lbs/mil to about 35 in-lbs/mil.

In at least one embodiment, a film of the present disclosure has a haze value of about 45% or less, about 40% or less, about 35% or less, about 30% or less, about 25% or less, about 20% or less, about 15% or less, or about 10% or less, as determined by ASTM D-1003.

In at least one embodiment, a film of the present disclosure has a clarity (defined as regular transmitted light that is deflected less than 0.1 from the axis of incident light through the bulk of the film sample) of about 80% or greater, about 85% or greater, about 90% or greater, about 95% or greater, about 97% or greater, as determined by ASTM D1746.

In at least one embodiment, a film of the present disclosure has a gloss of about 30% or greater, about 35% or greater, about 40% or greater, about 45% or greater, about 50% or greater, as determined by ASTM D-2457, where a light source is beamed onto the film surface at an angle of 45° and the amount of light reflected is measured.

### Shrink Films

Compositions of the present disclosure may be utilized to prepare shrink films. Shrink films, also referred to as heat-shrinkable films, are widely used in both industrial and retail bundling and packaging applications. Such films are capable of shrinking upon application of heat to release stress imparted to the film during or subsequent to extrusion. The shrinkage can occur in one direction or in both longitudinal and transverse directions. Conventional shrink films are described, for example, in U.S. Pat. No. 7,235,607, incorporated herein by reference.

Industrial shrink films can be used for bundling articles on pallets. Typical industrial shrink films are formed in a single bubble blown extrusion process to a thickness of about 80 to 200 μm, and provide shrinkage in two directions.

Retail films can be used for packaging and/or bundling articles for consumer use, such as, for example, in supermarket goods. Such films are typically formed in a single bubble blown extrusion process to a thickness of about 35 μm to about 80 μm.

Films may be used in “shrink-on-shrink” applications. “Shrink-on-shrink,” as used herein, refers to the process of applying an outer shrink wrap layer around one or more items that have already been individually shrink wrapped (herein, the “inner layer” of wrapping). In these processes, it may be desired that the films used for wrapping the individual items have a higher melting (or shrinking) point than the film used for the outside layer. When such a configuration is used, it is possible to achieve the desired level of shrinking in the outer layer, while preventing the inner layer from melting, further shrinking, or otherwise distorting during shrinking of the outer layer. Some films described herein may have a sharp shrinking point when subjected to heat from a heat gun at a high heat setting, which indicates that they may be especially suited for use as the inner layer in a variety of shrink-on-shrink applications.

### EXPERIMENTAL

General Considerations and Reagents: All manipulations were performed under an inert atmosphere using glove box techniques unless otherwise stated. Toluene and Pentane were purchased from Sigma Aldrich and were degassed and dried over 3 Å molecular sieves overnight prior to use. Methylaluminoxane was purchased from Grace and used as received.

### Syntheses:

General Considerations and Reagents. All manipulations were performed under an inert atmosphere using glove box techniques unless otherwise stated. Diethyl ether and dichloromethane (Sigma Aldrich) were degassed and dried over 3 Å molecular sieves overnight prior to use. ZrCl₄ was purchased from Strem Chemicals, Inc. and used as received.

### Synthesis of Catalyst 2 and Catalyst 1:

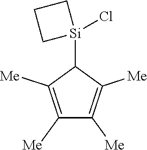 [SMILES: CC1=C(C)C([Si]2(Cl)CCC2)C(C)=C1C]

1-Chloro-1-(2,3,4,5-tetramethylcyclopenta-2,4-dien-1-yl) silacyclobutane

To a colorless solution of 1,1-dichlorosilacyclobutane (11.00 g, 78.0 mmol, 2.00 equiv.) in tetrahydrofuran (50 mL) at −35° C. was added lithium (tetramethylcyclopentadienide) (5.00 g, 39.0 mmol, 1.00 equiv.) to give a cloudy white mixture that slowly became clear over an hour. The reaction was stirred 3 hours, then evaporated under vacuum to give a soupy white mixture. The mixture was extracted with pentane (50 mL, then 4×5 mL) and the extracts were filtered to give a colorless solution. The solution was evaporated under vacuum to give an amber oil. Yield 8.79 g (99%). ¹H NMR (C₆D₆) δ 3.11 (br s, 1H), 1.98 (br m, 1H), 1.90 (s, 6H), 1.68-1.79 (overlapping multiplet and singlets, 7H), 1.21-1.40 (m, 4H).

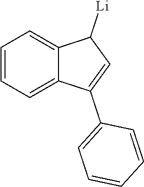

Lithium (3-phenylindenide)

To a colorless solution of 3-phenylindene (26.20 g, 136 mmol, 1.00 equiv.) in pentane (250 mL) was added 2.73M butyllithium (50.0 mL, 136 mmol, 1.00 equiv.) to give a hazy yellow solution. The reaction was stirred 69 hours to give a cloudy yellow mixture. The mixture was then filtered to give a light yellow solid. The solid was washed with pentane (100 mL) and dried under vacuum. Yield 25.71 g (95%). ¹H NMR (THF-d8) δ 7.72 (dm, 1H), 7.55 (dm, 2H), 7.19 (dm, 1H), 7.02 (tm, 2H), 6.86 (d, 1H), 6.51 (tm, 1H), 6.47 (tm, 1H), 6.37 (tm, 1H), 5.93 (dd, 1H).

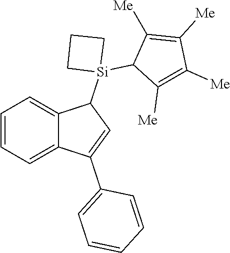 [SMILES: CC1=C(C)C([Si]2(C3C=C(c4ccccc4)c4ccccc43)CCC2)C(C)=C1C]

1-(3-Phenyl-1H-inden-1-yl)-1-(2,3,4,5-tetramethylcyclopenta-2,4-dien-1-yl) silacyclobutane

To an amber solution of 1-chloro-1-(2,3,4,5-tetramethylcyclopenta-2,4-dien-1-yl) silacyclobutane (5.14 g, 22.7 mmol, 1.00 equiv.) in ether (25 mL) at −35° C. was added lithium (3-phenylindenide) (4.81 g, 24.3 mmol, 1.07 equiv.) to give a cloudy yellow-orange mixture. The reaction was allowed to warm to room temperature and stirred 24 hours to give a cloudy green-white mixture. The reaction was then evaporated under vacuum, leaving a greenish semi-solid. The residue was extracted with pentane (3×30 mL, then 3×5 mL) and the extract was filtered to give a yellow solution. The solution was evaporated under vacuum, leaving manila solid. Yield 8.41 g (97%). ¹H NMR (C₆D₆) δ 7.73 (m, 1H), 7.66 (m, 1H), 7.64. (m, 1H), 7.46 (m, 1H), 7.27 (m, 2H), 7.22 (m, 2H), 7.17 (m, 2H), 6.49 (d, 1H), 3.36 (d, 1H), 2.98 (br s, 1H), 1.95 (m, 1H), 1.91 (s, 3H), 1.88 (s, 3H), 1.78 (s, 3H), 1.75 (s, 6H), 1.54 (m, 1H), 1.13-1.26 (m, 2H), 1.02 (m, 1H), 0.81 (m, 1H).

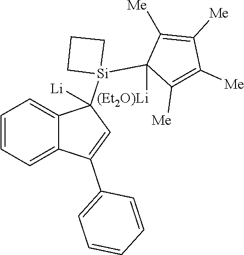

Dilithium [tetramethylcyclopentadienidesilacyclobutyl(3-phenylindenide)] (ether)

To a hazy amber solution of 1-(3-phenyl-1H-inden-1-yl)-1-(2,3,4,5-tetramethylcyclopenta-2,4-dien-1-yl) silacyclobutane (8.27 g, 21.6 mmol, 1.00 equiv.) in ether (40 mL) at −35° C. was added 2.74M butyllithium in hexanes (16.4 mL, 44.9 mmol, 2.08 equiv.) to give a cloudy yellow mixture. The reaction was allowed to warm to room temperature and stirred 17 hours. Pentane (40 mL) was added to the reaction and the mixture was filtered to give a yellow solid. The solid was washed with pentane and dried under vacuum. Yield 9.11 g (90%) yellow powder. ¹H NMR (THF-d8) δ 7.71 (d, 1H), 7.61 (d, 1H), 7.57 (dd, 2H), 7.18 (s, 1H), 7.02 (t, 1H), 6.55 (t, 1H), 6.50 (t, 1H), 6.41 (t, 1H), 3.40 (q, 4H), 2.27 (br m, 2H), 2.19 (s, 6H), 1.95 (s, 6H), 1.46 (br m, 4H), 1.13 (t, 6H).

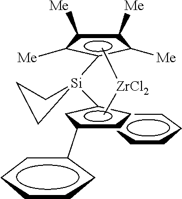

[Tetramethylcyclopentadienylsilacyclobutyl (3-phenylindenyl)] zirconium dichloride, Catalyst 2

To a vigorously stirred white suspension of zirconium tetrachloride bis(etherate) (3.25 g, 8.54 mmol, 1.00 equiv.) in ether (50 mL) at −35° C. was added dilithium [tetramethylcyclopentadienidesilacyclobutyl (3-phenylindenide)] (ether) (4.00 g, 8.54 mmol, 1.00 equiv.) to give a cloudy yellow mixture. The reaction was allowed to warm to room temperature and stirred 18 hours. The cloudy bright yellow mixture was then evaporated under vacuum, leaving yellow solid. The solid was extracted with dichlormethane (50 ml, then 4×5 mL) and the extracts were filtered to give a yellow solution. The solution was evaporated under vacuum, leaving yellow solid. The solid was washed with pentane and dried under vacuum, giving a bright yellow powder comprising Catalyst 2. Yield 4.26 g (92%). H NMR (CD₂Cl₂) δ 7.91 (dt, 1H), 7.61 (m, 1H), 7.59 (m, 1H), 7.47-7.52 (m, 3H) 7.39-7.41 (m, 1H) 7.34-7.38 (m, 1H), 7.06-7.10 (m, 1H), 6.01 (s, 1H), 2.64-2.81 (m, 2H), 2.04-2.18 (m, 2H), 1.93-1.99 (m, 2H), 1.95 (s, 3H), 1.91 (s, 3H), 1.90 (s, 3H), 1.85 (s, 3H).

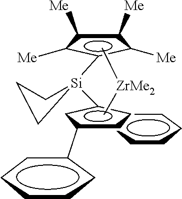

[Tetramethylcyclopentadienylsilacyclobutyl(3-phenylindenyl)]zirconium dimethyl, (Catalyst 1)

Catalyst 1 is obtained by continuing synthesis as follows: To a bright yellow suspension of [tetramethylcyclopentadienylsilacyclobutyl(3-phenylindenyl)]zirconium dichloride (Catalyst 2) (2.00 g, 3.69 mmol, 1.00 equiv.) in toluene (20 mL) at −35° C. was added 3.28M methylmagnesium bromide in ether (2.35 mL, 7.71 mmol, 2.09 equiv.) to give a cloudy yellow mixture. The reaction was allowed to warm to room temperature and stirred 18 hours. The hazy dark amber solution was then evaporated under vacuum, leaving yellow-brown solid. The solid was extracted with toluene (30 mL, then 3×5 mL) and the extracts were filtered to give a yellow solution. The solution was evaporated under vacuum, leaving yellow solid. Yield 1.77 g (96%). ¹H NMR (C₆D₆) δ 8.07 (dt, 1H), 7.69 (m, 2H), 7.28-7.35 (m, 3H), 7.21 (m, 1H), 7.13-7.18 (overlapping multiplets, 3H), 6.86 (m, 1H), 5.93 (s, 1H), 2.40-2.57 (m, 2H), 1.80 (s, 3H), 1.77 (s, 3H), 1.74 (s, 3H), 1.64-1.72 (m, 2H), 1.58 (m, 2H), 1.55 (s, 3H), −0.46 (s, 3H), −1.25 (s, 3H).

### Synthesis Prep. 2, Additional Catalyst 2:

To a vigorously stirred white suspension of zirconium tetrachloride bis(etherate) (2.00 g, 5.25 mmol, 1.00 equiv.) in ether (30 mL) at −35° C. was added dilithium [tetramethylcyclopentadienide)silacyclobutyl (3-phenylindenide)] (etherate) (2.46 g, 5.25 mmol, 1.00 equiv.) to give a cold, cloudy light yellow mixture. The reaction became cloudy bright yellow after stirring 20 minutes. The reaction was stirred 18 hours, then was evaporated under vacuum, leaving bright yellow solid. The solid was extracted with dichloromethane (30 mL, then 3×5 mL) and the extracts were filtered to give a bright yellow solution and dull yellow solid. The solution was evaporated under vacuum, leaving yellow solid. The solid was washed with pentane (20 mL) and dried under vacuum. The yield was 2.61 g (92%) bright yellow powder. 1H NMR (CD2Cl₂) δ 7.91 (dt, 1H), 7.60-7.58 (m, 2H), 7.53-7.47 (m, 3H), 7.43-7.34 (m, 2H), 7.10-7.06 (m, 1H), 6.01 (s, 1H), 2.80-2.65 (m, 2H), 2.15-2.06 (m, 2H), 1.97-1.93 (m, 1H), 1.94 (s, 3H), 1.92, (s, 3H), 1.90 (s, 3H), 1.85 (s, 3H).

### Synthesis Prep 2, Additional Catalyst 1:

To a yellow suspension of [tetramethylcyclopentadienylsilacyclobutyl(3-phenylindenyl)] zirconium dichloride (Catalyst 2) (2.00 g, 3.69 mmol, 1.00 equiv.) in toluene (20 mL) at −35° C. was added 3.28M methylmagnesium bromide in ether (2.35 mL, 7.71 mmol, 2.09 equiv.) to give a cold, cloudy yellow mixture. The reaction became hazy amber-yellow after stirring 30 minutes. The reaction was stirred 18 hours to give a hazy, dark amber-yellow mixture. The reaction was evaporated under vacuum, leaving yellow-brown solid. The solid was extracted with toluene (30 mL, then 3×5 mL) and the extracts were filtered to give a yellow solution and brown solid. The solution was evaporated under vacuum, leaving yellow solid. The yield was 1.77 g (96%). 1H NMR (CD₂Cl₂) δ 8.07 (dt, 1H), 7.70-7.68 (m, 2H), 7.35-7.28 (m, 3H), 7.23-7.13 (m, 2H), 6.89-6.84 (m, 1H), 5.93 (s, 1H), 2.53-2.42 (m, 2H), 1.80 (s, 3H), 1.77 (s, 3H), 1.75-1.66 (m, 2H), 1.74 (s, 3H), 1.61-1.56 (m, 2H), 1.55 (s, 3H), −0.46 (s, 3H), −1.25 (s, 3H).

### Synthesis of Catalyst 13 and Catalyst 14:

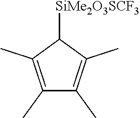

Dimethyl (2,3,4,5-tetramethylcyclopenta-2,4-dien-1-yl) silyl trifluoromethanesulfonate

To a pale amber solution of chlorodimethyl (2,3,4,5-tetramethylcyclopenta-2,4-dien-1-yl) silane (30.00 g, 140 mmol, 1.00 equiv.) in toluene (100 mL) was added silver trifluoromethanesulfonate (38.00 g, 148 mmol, 1.06 equiv.) to give a warm, cloudy white mixture that slowly turned gray-violet. The reaction was stirred 4 hours and then evaporated under vacuum, leaving a dark mixture. The mixture was extracted with pentane (100 mL, then 3×20 mL) and the extracts filtered to give a yellow solution. The solution was evaporated under vacuum, leaving yellow liquid. Yield 44.56 g (97%). ¹H NMR (C₆D₆) δ 2.77 (br s, 1H), 1.74 (s, 6H), 1.60 (s, 6H), 0.042 (s, 6H).

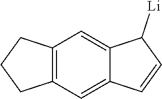

### Lithium Tetrahydroindacenide

To a yellow solution of 1,2,3,5-tetrahydro-s-indacene (12.70 g, 81.3 mmol, 1.00 equiv.) in ether (100 mL) at −35° C. was added 2.71M butyllithium (30.0 mL, 81.3 mmol, 1.00 equiv.) to give a cloudy manila mixture. The reaction was allowed to warm to room temperature and stirred 30 minutes. Pentane (80 mL) was added to the reaction and the mixture was filtered to give a manila solid. The solid was washed with pentane (40 mL) and dried under vacuum. Yield 13.05 g (99%). ¹H NMR (THF-d8) δ 7.16 (d, 2H), 6.42 (t, 1H), 5.81 (m, 2H), 2.84 (m, 4H), 1.97 (m, 2H).

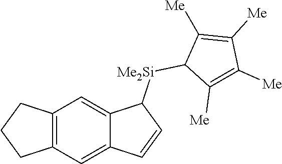

Dimethyl (1,5,6,7-tetrahydro-s-indacen-1-yl) (2,3,4,5-tetramethylcyclopenta-2,4-dien-1-yl)silane

To a light yellow solution of dimethyl (2,3,4,5-tetramethylcyclopenta-2,4-dien-1-yl) silyl trifluoromethanesulfonate (5.00 g, 15.2 mmol, 1.00 equiv.) in ether (20 mL) at −35° C. was added lithium tetrahydroindacenide (2.65 g, 16.2 mmol, 1.07 equiv.) to give a hazy amber-orange mixture. The reaction was allowed to warm to room temperature and stirred 16 hours to give a clear orange solution. The reaction was then evaporated under vacuum leaving an orange solid.

The solid was extracted with pentane (50 mL, then 3×20 mL) and the extract was filtered to give an amber solution. The solution was evaporated under vacuum, leaving an orange oil. Yield 5.04 g (99%). ¹H NMR (C₆D₆) δ 7.40 (s, 1H), 7.34 (s, 1H), 6.91 (dm, 1H), 6.50 (dd, 1H), 3.64 (s, 1H), 2.97 (br s, 1H), 2.85 (q, 4H), 1.90-1.96 (m, 8H), 1.83 (d, 6H), −0.09 (s, 3H), −0.35 (s, 3H).

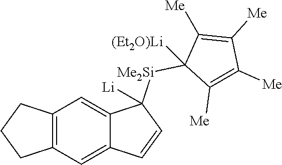

Dilithium [tetramethylcyclopentadienidedimethylsilyl(tetrahydroindacenide)](ether)

To an amber solution of dimethyl (1,5,6,7-tetrahydro-s-indacen-1-yl)(2,3,4,5-tetramethylcyclopenta-2,4-dien-1-yl) silane (5.00 g, 14.9 mmol, 1.00 equiv.) in ether (20 mL) at −35° C. was added 2.74M butyllithium in hexanes (11.3 mL, 31.0 mmol, 2.07 equiv.) to give a cloudy manila-orange mixture. The reaction was allowed to warm to room temperature and stirred 24 hours. Pentane (20 mL) was added to the reaction and the mixture was filtered to give a manila solid. The solid was washed with pentane and dried under vacuum. Yield 5.86 g (93%). ¹H NMR (THF-d8) δ 7.46 (s, 1H), 7.16 (s, 1H), 6.65 (d, 1H), 5.91 (d, 1H), 3.40 (q, 4H), 2.82 (m, 4H), 2.10 (s, 6H), 1.95 (m, 2H), 1.87 (s, 6H), 1.13 (t, 6H), 0.59 (br s, 6H).

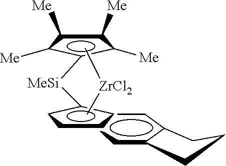

[Tetramethylcyclopentadienyldimethylsilyl(tetrahydroindacenyl)]zirconium dichloride (Catalyst 14)

To a vigorously stirred white suspension of zirconium tetrachloride bis(etherate) (2.00 g, 5.25 mmol, 1.00 equiv.) in ether (30 mL) at −35° C. was added dilithium [tetramethylcyclopentadienidedimethylsilyl(tetrahydroindacenide)](ether) (2.21 g, 5.25 mmol, 1.00 equiv.) to give a cloudy manila mixture. The reaction was allowed to warm to room temperature and stirred 18 hours. The cloudy bright yellow mixture was then evaporated under vacuum, leaving yellow solid. The solid was extracted with dichlormethane (30 ml, then 4×5 mL) and the extracts were filtered to give an orange solution. The solution was evaporated under vacuum, leaving yellow solid. The solid was washed with pentane and dried under vacuum, giving a bright yellow powder (Catalyst 14). Yield 2.22 g (86%). ¹H NMR (CD₂Cl₂) δ 7.47 (d, 1H), 7.30 (s, 1H), 7.07 (m, 1H), 5.87 (d, 1H), 2.90-3.10 (dm, 2H), 2.83 (m, 2H), 2.05 (m, 2H), 1.924 (s, 3H), 1.920 (s, 3H), 1.895 (s, 3H), 1.888 (s, 3H), 1.15 (s, 3H), 0.94 (s, 3H).

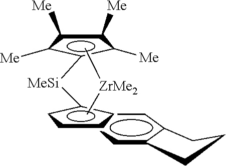

[Tetramethylcyclopentadienyldimethylsilyl(tetrahydroindacenyl)]zirconium dimethyl (Catalyst 13)

To a bright yellow suspension of [tetramethylcyclopentadienyldimethylsilyl (tetrahydroindacenyl)]zirconium dichloride (Catalyst 14) (1.00 g, 2.02 mmol, 1.00 equiv.) in toluene (10 mL) at −35° C. was added 3.28M methylmagnesium bromide in ether (1.30 mL, 4.26 mmol, 2.11 equiv.) to give a cloudy yellow mixture. The reaction was allowed to warm to room temperature and stirred 18 hours. The cloudy brown mixture was then evaporated under vacuum, leaving tan solid. The solid was extracted with toluene (25 mL, then 3×5 mL) and the extracts were filtered to give a yellow solution. The solution was evaporated under vacuum, leaving yellow solid. Yield 0.95 g (103%). ¹H NMR (C₆D₆) δ 7.47 (s, 1H), 7.25 (s, 1H), 7.04 (d, 1H), 5.55 (d, 1H), 2.89 (m, 1H), 2.78 (m, 1H), 2.70 (t, 2H), 1.87 (overlapping multiplet and singlet, 8H), 1.79 (s, 3H), 1.65 (s, 3H), 0.73 (s, 3H), 0.52 (s, 3H), −0.14 (s, 3H), −1.34 (s, 3H).

### Example: Trimming onto Base Catalyst B1

Base or Primary Catalyst B1 (dimethylsilylbis(tetrahydroindenyl) zirconium dimethyl metallocene) to be trimmed was synthesized as described in U.S. Pat. No. 5,314,973 followed by methylation with 2 equivalents of methyl magnesium bromide.

### Procedure of Trim of Catalyst 1:

iC6 trim solution is prepared by adding the neat Catalyst 1 (0.04 wt %) to the empty can and then filling the can with total desired mass (6 kg) with iC6 diluent.

### Procedure of Trim of Catalyst 13:

iC6 trim solution is prepared by adding the neat Catalyst 13 (0.04 wt %) to the empty can and then filling the can with total desired mass (6 kg) with iC6 solvent/diluent.

### Polymerizations

Gas phase fluidized bed polymerizations were carried out using the same reactor conditions (bed temperature ~185° F., pressure ~290 psig, same ethylene, hydrogen, and hexene comonomer flow ratios, and using ~10 mol % iC5 as an induced condensing agent, with ~25 mol % N₂ present), except with use of Catalyst B1 with no trim (Example 1) and with Catalyst 13 in iC6 solution trimmed into supported Catalyst B1 slurry at increasing relative amounts (Examples 2 and 3) as indicated in Table 1, with MI, HLMI, MIR, and density of each produced PE as also indicated in Table 1. Polymerizations at same conditions were repeated for Base Catalyst B1 (Example 4) and with Catalyst 13 in iC6 solution trimmed into supported Base Catalyst B1 slurry at similar relative amounts as in Example 3 (Example 5), as shown in Table 2 below.

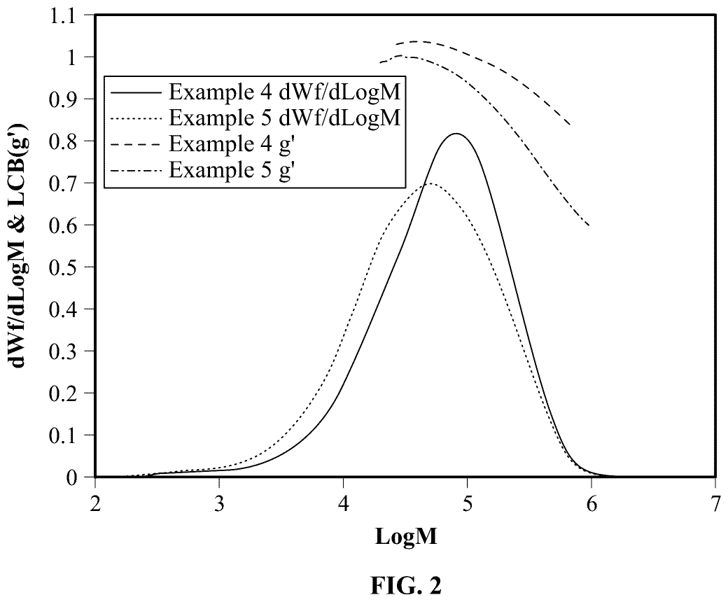

Table 3 below catalogues the molecular weight and g′ data obtained from GPC of Examples 1-5; which are also shown in FIG. 1 (for examples 1-3) and FIG. 2 (for examples 4-5). Table 3 and FIGS. 1 and 2 illustrate that with increasing relative amount of the trim catalysts, the PE copolymers exhibit lower g′ values (indicating greater and greater degrees of long chain branching), along with some very slight flattening and broadening of the molecular weight distribution as relatively more trim catalyst is used. This illustrates in general that one would expect the copolymers made using the trim catalysts to exhibit improved processability (as illustrated through decreasing g′ and broadening of molecular weight distribution).

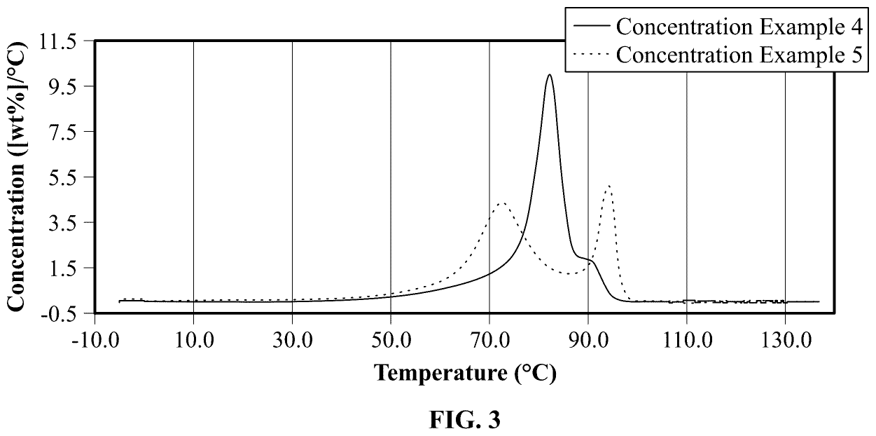

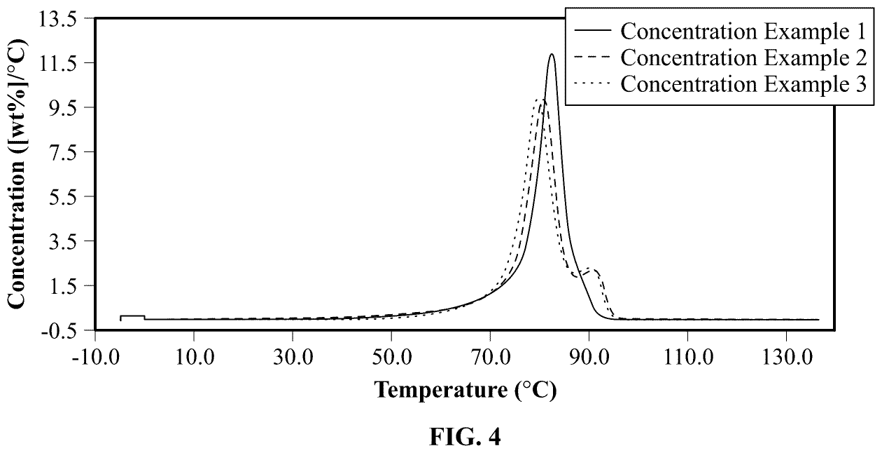

Table 4 catalogues CDBI and T75-T25 values (derived from TREF-IR5 distributions) of the PE copolymers, with TREF-IR5 distributions also illustrated in FIG. 3 (showing TREF-IR5 distributions of Examples 4 and 5) and FIG. 4 (showing TREF-IR5 distributions of Examples 1-3). One can see in Table 4 that with trim Catalyst 13, CDBI T75-T25 values remain reasonably similar from Example 1 (no trim) to Examples 2-3 (with the Trim Catalyst 13), indicating that this catalyst pair increases long chain branching while maintaining similar comonomer distribution among different-length polymer chains.

On the other hand, with trim Catalyst 1, per Table 4 and FIG. 3, we see that some broad orthogonal composition distribution (BOCD) is obtained: CDBI moderately decreases, consistent with a more uneven distribution of comonomer among different-length polymer chains; and T75-T25 values derived from TREF-IR5 increase. Consistently, FIG. 3 shows the clear bimodal crystallinity in the Example 5 PE (as illustrated through the two clearly distinct peaks for Example 5's TREF trace) compared to the PE copolymer of Example 4, made without trim. This could be explained by the differing distribution of comonomer across different-length polymer chains, creating distinct regions of higher and lower crystallinity, respectively, in the PE copolymer. Further, the larger T75-T25 value for Example 5 indicates the comonomer distribution of this PE is of a BOCD nature, meaning comonomer is preferentially incorporated onto longer polymer chains, and which is generally associated with superior processability without sacrificing strength properties in films made from such polyethylenes.

TABLE 1
Base Catalyst B1 Example Polymerizations

| Description | | Example 1 | Example 2 | Example 3 |
|---|---|---|---|---|
| Base Catalyst | | B1 | B1 | B1 |
| Trim | | | 0.04 wt %; | 0.04 wt %; |
| | | | Cat. 13 | Cat. 13 |
| amount collected | g | 176 | 194 | 191 |
| Start time (Drop time - 4 h) | | Day 1 0:15 | Day 1 10:15 | Day 1 2:15 |
| End time (Drop time - 2 h) | | Day 1 4:15 | Day 1 14:15 | Day 1 6:15 |
| MI | g/10 min | 0.478 | 0.469 | 0.478 |
| HLMI | g/10 min | 21.28 | 24.70 | 29.06 |
| MIR | | 44.50 | 52.68 | 60.75 |
| Density | g/cm³ | 0.9190 | 0.9201 | 0.9214 |
| Measured Production Rate | lb/hr | 44.1 | 49.2 | 46.9 |
| Catalyst Productivity | g/g | 7566 | 8438 | 8050 |
| Trim Concentration | wt % | n/a | 0.040 | 0.040 |
| Trim Solvent/Diluent | | n/a | iC6 | iC6 |
| Trim Solution Feed | g/hr | n/a | 10.1 | 21.0 |
| Trim Catalyst Feed Rate | g/hr | n/a | 4.03E−03 | 8.39E−03 |
| TRIM soln / Base Cat slurry | g/hr / cc/hr | | 0.720 | 1.498 |

TABLE 2
Additional Base Catalyst B1 Example Polymerizations

| Description | | Example 4 | Example 5 |
|---|---|---|---|
| Base Catalyst | | B1 | B1 |
| Trim | | | 0.04 wt %; |
| | | | Cat. 1 |
| amount collected | g | 197 | 360 |
| Start time (Drop time - 4 h) | | Day 1 20:15 | |
| End time (Drop time - 2 h) | | Day 2 0:15 | |
| MI | g/10 min | 0.484 | 0.922 |
| HLMI | g/10 min | 21.75 | 56.73 |
| MIR | | 44.95 | 61.53 |
| Density | g/cm³ | 0.9197 | 0.9229 |
| Measured Production Rate | lb/hr | 49.0 | 53.5 |
| Catalyst Productivity | g/g | 7353 | 9183 |
| Trim Concentration | wt % | n/a | 0.040 |
| Trim Solvent/Diluent | | n/a | iC6 |
| Trim Solution Feed | g/hr | n/a | 21.5 |
| Trim Catalyst Feed Rate | g/hr | n/a | 8.60E−03 |

TABLE 3
GPC Data Increasing Processability as Measured by g′ using
Trim Metallocenes Catalyst 13 and Catalyst 1 with Base Catalyst B1.

| | Mn(LS) | Mw(LS) | PDI | Mz(LS) | Hexene wt % | g′ (vis avg.) | MI | MIR | Density (g/cm³) |
|---|---|---|---|---|---|---|---|---|---|
| Example 1 | 22783 | 109621 | 4.81 | 220434 | 7.61 | 0.959 | 0.478 | 44.5 | 0.9190 |
| Example 2 | 22555 | 113378 | 5.03 | 254797 | 7.82 | 0.916 | 0.469 | 52.68 | 0.9201 |
| Example 3 | 21395 | 121306 | 5.67 | 332799 | 7.61 | 0.864 | 0.478 | 60.75 | 0.9214 |
| Example 4 | 20656 | 108257 | 5.24 | 233132 | 7.99 | 0.966 | 0.484 | 44.95 | 0.9197 |
| Example 5 | 15781 | 100020 | 6.34 | 280936 | 8.70 | 0.829 | 0.922 | 61.53 | 0.9229 |

Gel permeation chromatography via 4D GPC

TABLE 4
TREF data

| | Example 1 | Example 2 | Example 3 | Example 4 | Example 5 |
|---|---|---|---|---|---|
| CDBI | 83.66% | 75.89% | 80.73% | 74.62% | 57.85% |
| T75-T25 | 5.9 °C | 6.7 °C | 6.4 °C | 7.5 °C | 19.4 °C |

### Film Production with Examples 1-5

Example 1-3 and 5 PE copolymer resins were compounded with stabilizers into pellet resins through simple melt blending on lab scale twin screw extruders such as Coperion W&P 57 under typical PE compounding conditions. Prior to melt mixing, the polyethylene resins in granular forms were dry blended in a tumble mixer with the following additives: 500 ppm of Irganox™-1076, 1,000 ppm of Irgafos™ 168, and 600 ppm of Dynamar™ FX5920A.

The above-obtained pellets of Examples 1-3 and 5, plus commercially available Enable 2005HH (Commercial C1) were converted into monolayer films on a 2.5″ Battenfeld Gloucester line with 30:1 L:D equipped with a 6″ oscillating die and a Future Design air ring. The die gap was 60 mil die gap and the blow-up ratio (BUR) was 2.5. Table 5 shows film properties (as well as a repeat of MI, HLMI, and MIR of the underlying polymers used therein.

TABLE 5
Film Data for Polymers Obtained Using Base Catalyst B1

| Example | Commercial C1 | Example 1 | Example 2 | Example 3 | Example 5 |
|---|---|---|---|---|---|
| | Enable | B1 | B1 + | B1 + | B1 + |
| | 20-05HH | | trim13 | higher | higher |
| | | | | trim13 | trim1 |
| Film gauge | 0.99 | 1.02 | 1.02 | 1.03 | 1.03 |
| (mil) | | | | | |
| I₂, g/10 min | 0.533 | 0.493 | 0.573 | 0.589 | 0.882 |
| I₂₁, g/10 min | 20.73 | 19.90 | 25.39 | 31.16 | 54.54 |
| I₂₁/I₂ | 38.88 | 40.36 | 44.30 | 52.90 | 61.83 |
| Density, g/cm³ | 0.9203 | 0.9208 | 0.9216 | 0.9226 | 0.9232 |
| Dart Drop, | 185.4 | 190.2 | 187.3 | 157.7 | 133.0 |
| Phenolic, g/mil | | | | | |
| Elmendorf | 90.0 | 93.6 | 90.7 | 65.5 | 86.4 |
| Tear, g/mil - | | | | | |
| MD | | | | | |
| 1% Secant, | 29842 | 30328 | | 34493 | 35254 |
| psi - MD | | | | | |
| Puncture Break | 38.1 | 41.9 | 33.9 | 30.2 | 27.0 |
| Energy, in- | | | | | |
| lbs/mil | | | | | |
| Haze, % | 7.4 | 8.3 | 10.0 | 13.7 | 13.4 |
| Clarity, % | 98.6 | 98.6 | 97.6 | 96.4 | 95.5 |
| Gloss_MD, | 58.0 | 56.8 | 49.6 | 40.7 | 43.6 |
| GU | | | | | |
| % motor load | 51 | 63.6 | 57.8 | 53.9 | 42.8 |
| Head Pressure | 4940 | 5230 | 4740 | 4230 | 3240 |
| (psi) | | | | | |
| Melt (° F.) | 402 | 402 | 400 | 398 | 392 |
| Horsepower | 20 | 22 | 20 | 19 | 15 |
| Shrink_MD | 71.0 | 72.0 | 72.0 | 71.0 | 72.0 |
| (%) | | | | | |
| Shrink_TD | −3.0 | −2.0 | −1.0 | −1.0 | 2.0 |
| (%) | | | | | |

### Example: Trimming onto Base Catalyst B2

Base Catalyst B2 (n-propyl cyclopentadienyl) 2 hafnium dichloride) was synthesized/supported analogous to preparation in U.S. Pat. No. 6,936,675.

### Procedure of Trim of Catalyst 1:

iC6 trim solution is prepared by adding the neat Catalyst 1 (0.04 wt %) to the empty can and then filling the can with total desired mass (6 kg) with solvent.

### Procedure of Trim of Catalyst 13:

iC6 trim solution is prepared by adding the neat Catalyst 13 (0.04 wt %) to the empty can and then filling the can with total desired mass (6 kg) with solvent.

### Polymerizations of B2 Examples

Gas phase fluidized bed polymerizations were carried out using the same reactor conditions (bed temperature ~170° F., pressure ~290 psig, same ethylene, hydrogen, and hexene comonomer flow ratios, and using ~10 mol % iC5 as an induced condensing agent, with ~25 mol % N₂ present), except with use of Catalyst B2 with no trim (Example C2) and with Catalyst 13 in iC6 solution trimmed into supported Catalyst B2 slurry at increasing relative amounts (Examples 6 and 7) as indicated in Table 6; and with the further exception that for Example 8, substantially less hydrogen was used (approx. 30% of the hydrogen used in Examples 6 and 7) in the reaction to test production of PE copolymers with substantially fewer short polymer chains (higher Mn). MI, HLMI, MIR, and density of each produced PE as also indicated in Table 6. Polymerizations at same conditions as Examples 6 and 7 were repeated for Base Catalyst B2 with a relatively high amount (Example 9) and low amount (Example 10), respectively, of Catalyst 1 in iC6 solution trimmed into the supported Catalyst B2 slurry, as shown in Table 7 below.

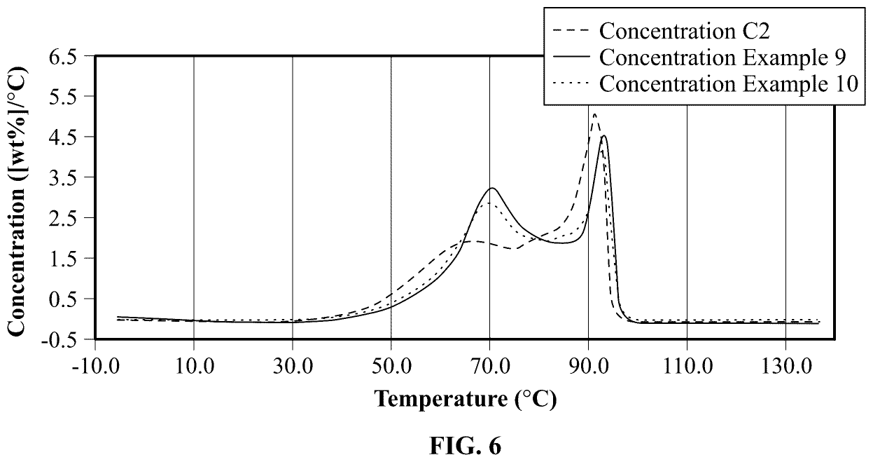

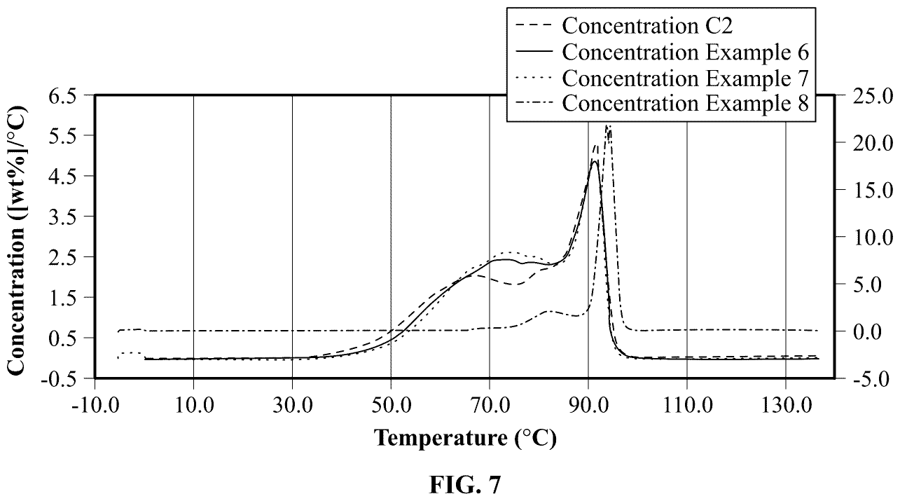

As can be seen, Example 8 indicated that excessively high Mn (e.g., greater than 35,000 g/mol) likely reduces the long-chain-branching production from the trim catalyst process; but all other examples consistently showed that the trim catalysts led to increased presence of long-chain branching (lower g′ values, see Table 8), while maintaining a very similar comonomer distribution profile that indicates a moderate degree of BOCD (as shown in CDBI and T75-T25 values, see Table 9) when using B2+trim, as compared to using B2 alone (which, as can be seen, produced BOCD polyethylene copolymers without appreciable LCB, see Tables 8 and 9). See also FIG. 6 (TREF-IR5 profiles of Examples C2, 9 and 10) and FIG. 7 (TREF-IR5 profiles of Examples C2 and 6-8), where distinct peaks of crystallinity indicating crystalline bimodality can be seen. Thus, it is seen that B2+trim catalysts provide a unique combination of moderate LCB and BOCD in LLDPE copolymers.

TABLE 6
Base Catalyst B2 Example Polymerization Data

| Description | | Example C2 | Example 6 | Example 7 | Example 8 |
|---|---|---|---|---|---|
| Base Catalyst | | B2 | B2 | B2 | B2 |
| Trim | | | 0.04 wt %; | 0.04 wt %; | 0.04 wt %; |
| | | | Catalyst 13 | Catalyst 13 | Catalyst 13 |
| amount collected | | 181 | 168 | 212 | 209 |
| Start time (Drop time - 4 h) | | Day 1, 8:15 | Day 3, 12:15 | Day 5, 0:15 | Day 6, 4:15 |
| End time (Drop time - 2 h) | | Day 1, 12:15 | Day 3, 16:15 | Day 5, 4:15 | Day 6, 8:15 |
| MI | g/10 min | 0.862 | 0.483 | 0.248 | ** |
| HLMI | g/10 min | 25.39 | 20.37 | 14.54 | 3.64 |
| MIR | | 29.45 | 42.13 | 58.52 | ???? |
| Density | g/cm³ | 0.9164 | 0.9179 | 0.9161 | 0.9262 |
| Catalyst Productivity | g/g | 7537 | 7357 | 10147 | 7624 |
| Trim Catalyst Feed Rate | g/hr | | 9.02E−03 | 1.37E−02 | 1.61E−02 |

** MI for Example 8 was not obtained because it was too low to adequately flow in standard test equipment

TABLE 7
Additional Base Catalyst B2 Example Polymerization Data

| Description | | Example 9 | Example 10 |
|---|---|---|---|
| Base Catalyst | | B2 | B2 |
| Trim | | 0.04 wt %; | 0.04 wt %; |
| | | Catalyst 1 | Catalyst 1 |
| amount collected | | 203 | 197 |
| Start time (Drop time - 4 h) | | Day 1, 14:15 | Day 3, 4:15 |
| End time (Drop time - 2 h) | | Day 1, 18:15 | Day 3, 8:15 |
| MI | g/10 min | 0.518 | 0.793 |
| HLMI | g/10 min | 21.95 | 27.40 |
| MIR | | 42.41 | 34.56 |
| Density | g/cm³ | 0.9202 | 0.9184 |
| Catalyst Productivity | g/g | 7747 | 8052 |
| Trim Catalyst Feed Rate | g/hr | 1.48E−02 | 9.74E−03 |
| TRIM soln / CAT slurry | g/hr / | 2.462 | 1.623 |
| | cc/hr | | |

TABLE 8
4D GPC Data Increasing Processability as Measured by g′
using Trim Metallocenes 1 and 13 with Base Catalyst B2.

| | Mn(LS) | Mw(LS) | PDI | Mz(LS) | Hexene wt % | g′ (vis avg.) | MI | MIR | density |
|---|---|---|---|---|---|---|---|---|---|
| Comparative | 26772 | 125656 | 4.69 | 292798 | 9.18 | 0.962 | 0.862 | 29.45 | 0.9164 |
| Example C2 | | | | | | | | | |
| Example 6 | 28250 | 173146 | 6.13 | 693313 | 9.29 | 0.796 | 0.483 | 42.13 | 0.9179 |
| Example 7 | 29859 | 204021 | 6.83 | 859206 | 9.22 | 0.728 | 0.286 | 52.67 | 0.9163 |
| Example 8 | 42692 | 158230 | 3.71 | 346029 | 4.04 | 0.933 | HLMI 3.64 | | 0.9262 |
| Comparative | 26772 | 125656 | 4.69 | 292798 | 9.18 | 0.962 | 0.862 | 29.45 | 0.9164 |
| Example C2 | | | | | | | | | |
| Example 9 | 26220 | 142794 | 5.44 | 435750 | 8.71 | 0.807 | 0.518 | 42.31 | 0.9202 |
| Example 10 | 21978 | 128285 | 5.84 | 406616 | 9.17 | 0.844 | 0.793 | 34.56 | 0.9184 |

TABLE 9
TREF Data

| | C2 | Example 6 | Example 7 | Example 8 | Example 9 | Example 10 |
|---|---|---|---|---|---|---|
| CDBI | | 47.69% | 49.25% | 59.25% | 53.04% | 50.74% |
| T75-T25 | 23.3 °C | 20.6 °C | 20.1 °C | 5.0 °C | 20.3 °C | 21.1 °C |

### Film Production with Examples C2 and 6-9

Example C2 and 6-9 PE copolymer resins were compounded with stabilizers into pellet resins through simple melt blending on lab scale twin screw extruders such as Coperion W&P 57 under typical PE compounding conditions. Prior to melt mixing, the polyethylene resins in granular forms were dry blended in a tumble mixer with the following additives: 500 ppm of Irganox™-1076, 1,000 ppm of Irgafos™ 168, and 600 ppm of Dynamar™ FX5920A.

The above-obtained pellets were converted into monolayer films on a 2.5″ Battenfeld Gloucester line with 30:1 L:D equipped with a 6″ oscillating die and a Future Design air ring. The die gap was 60 mil die gap and the blow-up ratio (BUR) was 2.5. Table 10 shows film properties (as well as a repeat of MI, HLMI, and MIR of the underlying polymers used therein). The BOCD +LCB PE copolymers all exhibited substantially improved shrink properties as compared to the film made from C2 PE copolymer, while also exhibiting improved processability.

TABLE 10
Film data for Polyethylenes prepared from Base Catalyst B2

| | C2 | Example 6 | Example 7 | Example 8 | Example 9 |
|---|---|---|---|---|---|
| Film gauge (mil) | 1.02 | 1.02 | 1.05 | 1.07 | 1.00 |
| I₂, g/10 min | 0.971 | 0.551 | 0.381 | 0.616 | 0.796 |
| I₂₁, g/10 min | 26.09 | 20.38 | 18.13 | 24.35 | 27.49 |
| I₂₁/I₂ | 26.87 | 36.99 | 47.58 | 39.53 | 34.54 |
| Density, g/cm³ | 0.9186 | 0.9179 | 0.9174 | 0.9201 | 0.92 |
| Dart Drop, Phenolic, | 937.3 | 546.4 | 480.8 | 198 | 237.1 |
| g/mil | | | | | |
| Elmendorf Tear, g/mil - MD | 238 | 49.1 | 36.4 | 52.7 | 69 |
| 1% Secant, psi - MD | 30086 | 31198 | 32308 | 34013 | 32291 |
| Puncture Break Energy, | 35.5 | 30.3 | 26.0 | 23.4 | 27.7 |
| in-lbs/mil | | | | | |
| Haze, % | 19 | 30 | 30 | 21.3 | 14 |
| Clarity, % | 96.8 | 73.7 | 59.8 | 88.6 | 93.1 |
| Gloss_MD, GU | 16.6 | 13.2 | 9.9 | 24.2 | 36.9 |
| % motor load | 43.2 | 48.5 | 55.5 | 42 | 41 |
| Head Pressure (psi) | 3530 | 3460 | 3820 | 3200 | 3140 |
| Melt (° F.) | 403 | 403 | 405 | 399 | 400 |
| Horsepower | 16 | 17 | 19 | 15 | 15 |
| Shrink_MD (%) | 56 | 68 | 69 | 72 | 70 |
| Shrink_TD (%) | −15 | −3 | 0 | −1 | −4 |

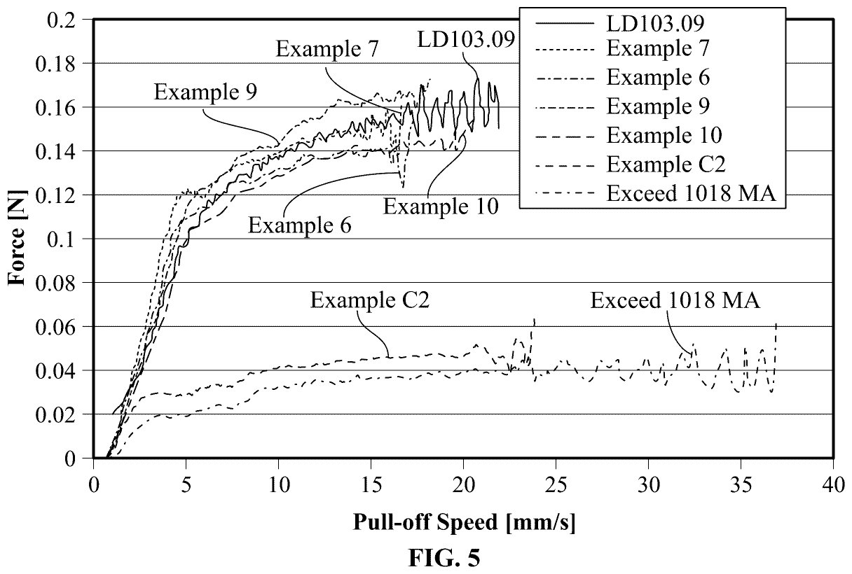

Furthermore, FIG. 5 is a graph illustrating pull off speed versus force of PE copolymers of Examples C2, 6-7, and 9-10; and also pull off speed versus force for two commercial polyethylenes: LD103.09, a free radical polymerized LDPE (0.919 g/cm³ density; 12.16 of 1.1 g/10 min) having substantial long chain branching, and Exceed™ 1018 MA, a mLLDPE (0.918 g/cm³ density; I_{2.16} of 1.0 g/10 min) with no long chain branching. Both are available from ExxonMobil Product Solutions Company of Spring, TX. As can be seen, the Example 6-7 and 9-10 PE copolymers achieved similar pull-off force vs. speed profiles as the LD103 LDPE, far superior to the more standard mLLDPEs of C₂ and Exceed 1018 MA (lacking the LCB).

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

All priority documents are herein fully incorporated by reference for all purposes and for all jurisdictions in which such incorporation is permitted and to the extent such description is consistent with the present disclosure. Further, all documents and references cited herein, including testing procedures, publications, patents, journal articles, etc. are herein fully incorporated by reference for all jurisdictions in which such incorporation is permitted and to the extent such description is consistent with the disclosure.

Likewise, whenever a composition, an element, or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the claimed invention, additionally, the phrases do not exclude impurities and variances normally associated with the elements and materials used.

While the claimed invention is described with respect to a number of embodiments and examples, those skilled in the art, having benefit of this disclosure, will appreciate that other embodiments can be devised which do not depart from the scope and spirit of the disclosure.

What is claimed is:

1. A method for producing a polyethylene copolymer comprising:
contacting a first composition and a second composition in a line to form a third composition, wherein:
the first composition comprises a contact product of a first diluent, a first catalyst compound, a support material, and an activator,
the second composition comprises a contact product of a second diluent and a second catalyst compound;
introducing the third composition from the line into a gas-phase fluidized bed reactor;
exposing the third composition to polymerization conditions by polymerizing ethylene and at least one C₃-C₂₀ alpha-olefin by introducing the ethylene and the at least one C₃-C₂₀ alpha-olefin into the gas-phase fluidized bed reactor; and
obtaining the polyethylene copolymer,
wherein the second catalyst compound is represented by Formula (III) or Formula (IV): 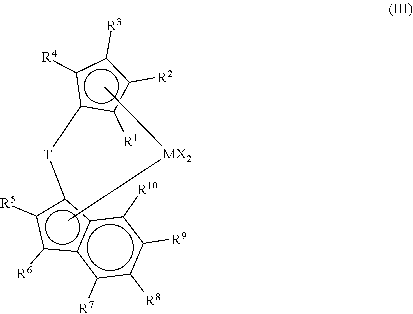
wherein:
M of Formula (III) is a group 4 metal;
each of R¹, R², R³, R⁴, R⁵, R⁶, R⁷, R⁸, R⁹, and R¹⁰ of Formula (III) is independently hydrogen, a substituted or unsubstituted hydrocarbyl, a substituted or unsubstituted heteroatom, or a substituted or unsubstituted heteroatom-containing group, optionally wherein one or more of R⁵ and R⁶, R⁷ and R⁸, R⁸ and R⁹, and R⁹ and R¹⁰ are joined to form a substituted or unsubstituted completely saturated ring or a substituted or unsubstituted aromatic ring, and further wherein at least one of R⁵ or R⁶ is independently a substituted or unsubstituted aryl group or a substituted or unsubstituted heteroaryl group;
T of Formula (III) is represented by formula R^{a}₂J, (R^{a})₄J₂, or (R^{a})₆J₃ wherein each J is independently carbon, silicon, or germanium, and each R^{a} is independently hydrogen, halide, a substituted or unsubstituted C₁ to C₄₀ hydrocarbyl, and wherein two R^{a} optionally can be joined to form a substituted or unsubstituted completely saturated ring, or a substituted or unsubstituted partially saturated ring; and
each X of Formula (III) is independently a halide, a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene; 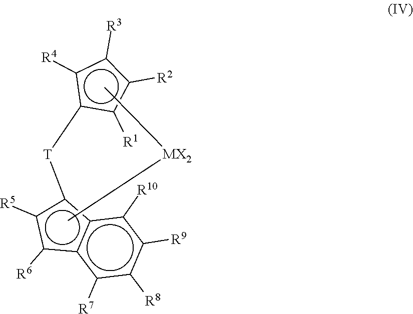
wherein:
M of Formula (IV) is a group 4 metal;
each of R¹, R², R³, R⁴, R⁵, R⁶, R⁷, R⁸, R⁹, and R¹⁰ of Formula (IV) is independently hydrogen, a substituted or unsubstituted hydrocarbyl, a substituted or unsubstituted heteroatom, or a substituted or unsubstituted heteroatom-containing group, optionally wherein one or more of R⁵ and R⁶, R⁷ and R⁸, R⁸ and R⁹, and R⁹ and R¹⁰ of Formula (IV) are joined to form a substituted or unsubstituted completely saturated ring or a substituted or unsubstituted aromatic ring, wherein at least one of (1) R⁷ and R⁸, (2) R⁸ and R⁹, or (3) R⁹ and R¹⁰ are joined to form a substituted or unsubstituted completely saturated ring fused to the indenyl ring shown in Formula (IV);
T of Formula (IV) is represented by formula R^{a}₂J, (R^{a})₄J₂, or (R^{a})₆J₃ wherein each J is independently carbon, silicon, or germanium, and each R^{a} is independently hydrogen, halide, a substituted or unsubstituted C₁ to C₄₀ hydrocarbyl, or two R^{a} can form a substituted or unsubstituted completely saturated ring, a substituted or unsubstituted partially saturated ring, or a substituted or unsubstituted aromatic ring; and
each X of Formula (IV) is independently a halide, a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene.

2. The method of claim 1, wherein the second catalyst is represented by the Formula (III) and wherein at least one of R⁵ or R⁶ of Formula (III) is hydrogen and/or wherein R⁵ or R⁶ of Formula (III) is an aryl group represented by the formula: 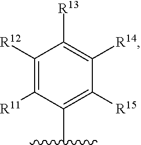
wherein each of R¹¹, R¹², R¹³, R¹⁴, and R¹⁵ is independently hydrogen, hydrocarbyl, a heteroatom, or heteroatom-containing group, or one or more of R¹¹ and R¹², R¹² and R¹³, R¹³ and R¹⁴, and R¹⁴ and R¹⁵ are joined to form a completely saturated, partially saturated, or aromatic ring and optionally wherein each of R¹¹, R¹², R¹³, R¹⁴, and R¹⁵ of Formula (III) is independently hydrogen or C₁-C₁₀ alkyl and/or wherein each of R¹, R², R³, and R⁴ of Formula (III) is C₁-C₁₀ alkyl and/or wherein each of R¹, R², R³, and R⁴ of Formula (III) is methyl and/or wherein each of R⁷, R⁸, R⁹, and R¹⁰ of Formula (III) is hydrogen and/or wherein T of Formula (ID is selected from the group consisting of Si(CH₂)₃, Si(CH₂)₄, and Si(CH₂)₅ and/or wherein M of Formula (III) is zirconium or hafnium, and each X of Formula (III) is independently halide or C₁-C₅ alkyl.

3.-11. (canceled)

12. The method of claim 2, wherein the catalyst compound is selected from the group consisting of:

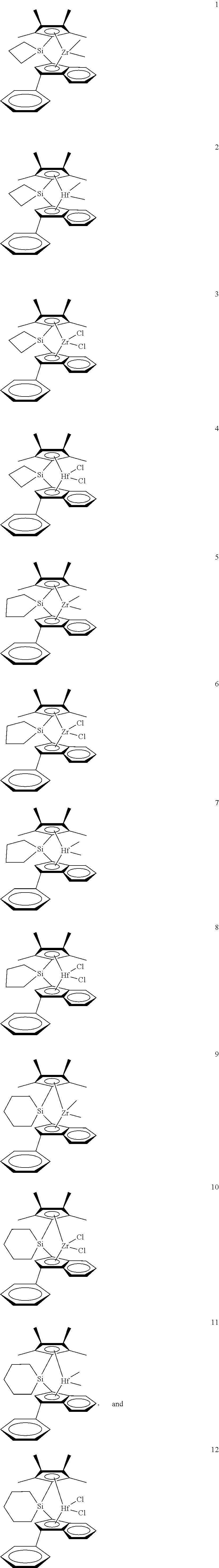

13. The method of claim 12, wherein the catalyst compound of Formula (III) is selected from the group consisting of:

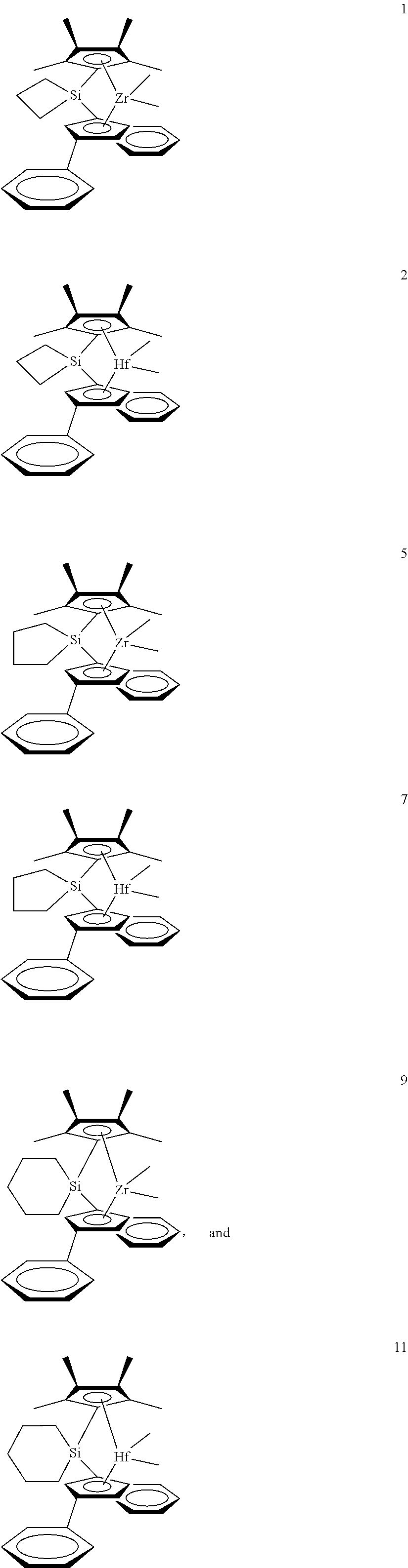

14. The method of claim 1, wherein the second catalyst is represented by the Formula (IV), wherein each of R⁷, R⁸, R⁹, and R¹⁰ of Formula (IV) is independently hydrogen or C₁-C₁₀ alkyl with the proviso that at least one of (1) R⁷ and R⁸, (2) R⁸ and R⁹, or (3) R⁹ and R¹⁰ are joined to form a substituted or unsubstituted completely saturated ring fused to the indenyl ring shown in Formula (IV) and/or wherein at least one of (1) R⁷ and R⁸, (2) R⁸ and R⁹, or (3) R⁹ and R¹⁰ are joined to form a substituted or unsubstituted completely saturated ring fused to the indenyl ring shown in Formula (IV), and/or wherein R⁷ and R⁸ are joined to form a substituted or unsubstituted saturated C₄ ring, a substituted or unsubstituted saturated C₅ ring, a substituted or unsubstituted saturated C₆ ring or a substituted or unsubstituted saturated C₇ wherein the C₄ ring, C₅ ring, C₆ ring, or C₇ ring is fused to the indenyl ring shown in Formula (IV), and/or wherein R⁸ and R⁹ are joined to form a substituted or unsubstituted saturated C₄ ring, a substituted or unsubstituted saturated C₅ ring, a substituted or unsubstituted saturated C₆ ring, or a substituted or unsubstituted saturated C₇ ring, wherein the C₄ ring, C₅ ring, C₆ ring, or C₇ ring is fused to the indenyl ring shown in Formula (IV), and/or wherein R⁹ and R¹⁰ are joined to form a substituted of unsubstituted saturated C₄ ring, a substituted or unsubstituted saturated C₅ ring, a substituted or unsubstituted saturated C₆ ring, or a substituted or unsubstituted saturated C₇ ring, wherein the C₄ ring, C₅ ring, C₆ ring, or C₇ ring is fused to the indenyl ring shown in Formula (IV), and/or wherein each of R¹, R², R³, and R⁴ of Formula (IV) s independently hydrogen or C₁-C₁₀ alkyl, and/or wherein each of R¹, R², R³, and R⁴ of Formula (IV) is methyl and/or wherein T is selected from the group consisting of SiMe₂, SiEt₂, and SiMeEt, and/or wherein: M is zirconium or hafnium, and each X is independently halide or C₁-C₈ alkyl.

15.-23. (canceled)

24. The method of claim 1, wherein the second catalyst is represented by the Formula (IV) and wherein the catalyst compound of Formula (IV) is selected from the group consisting of:

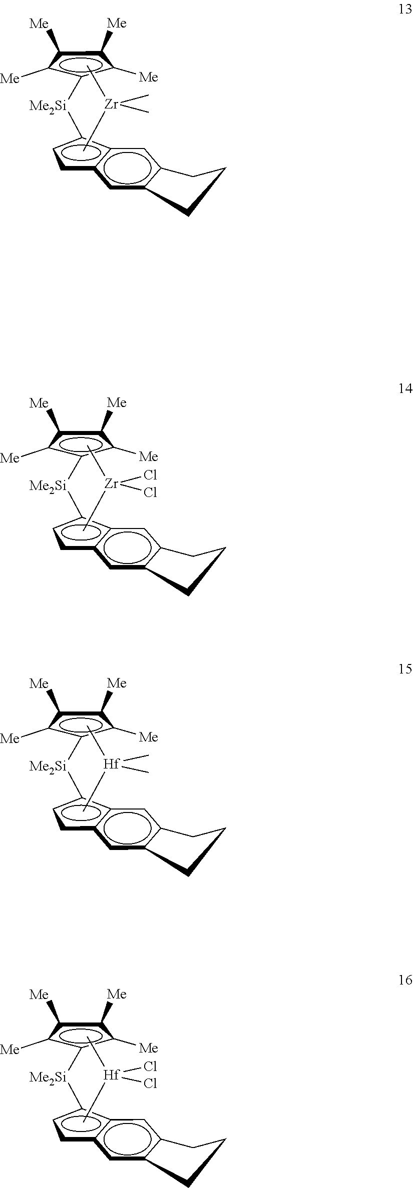

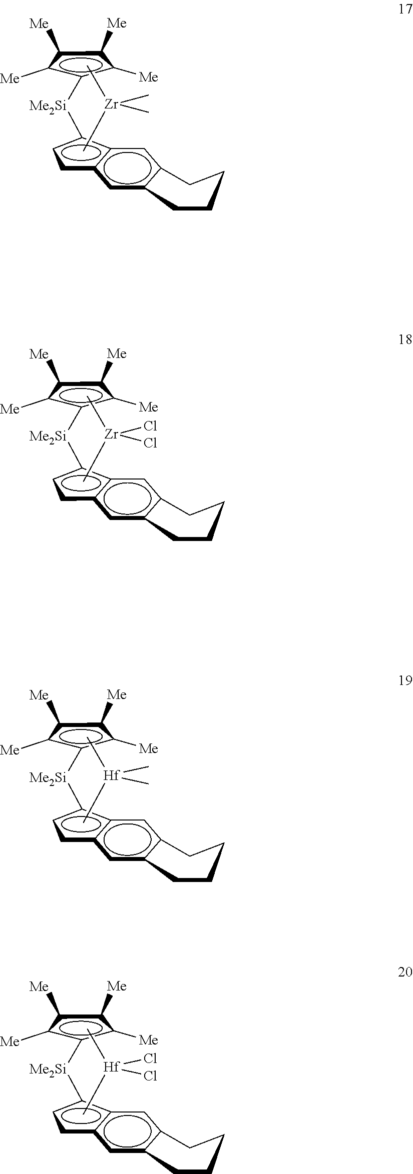

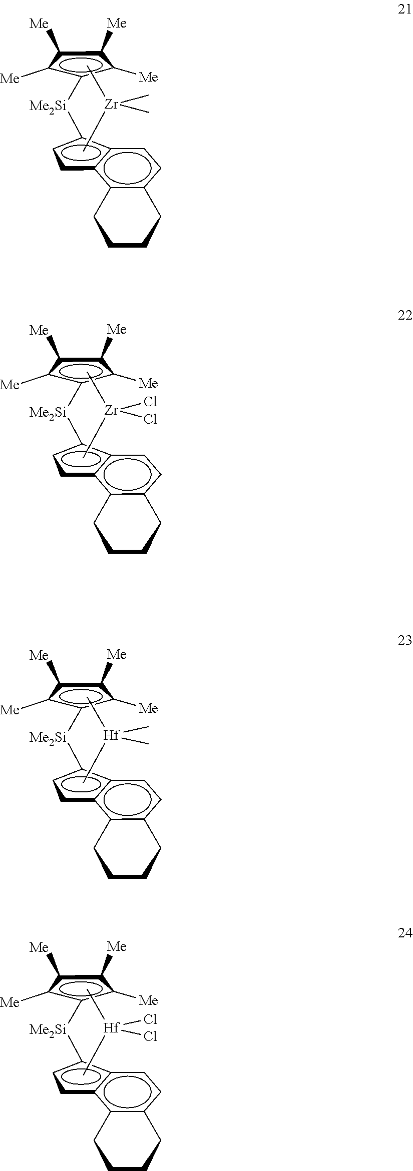

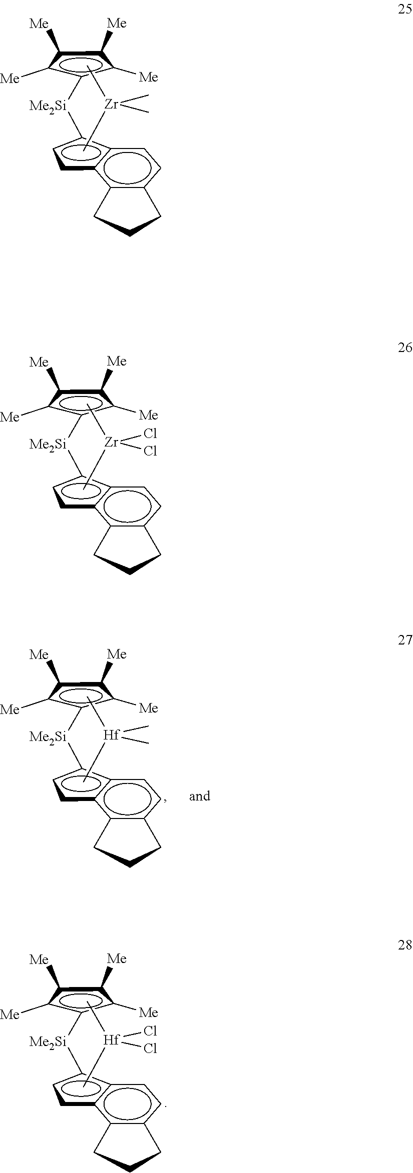

25. The method of claim 1, wherein the polymerization conditions comprise:
a reactor pressure of about 250 psig to about 350 psig; and
a reactor temperature of about 70° C. to about 110° C.

26. The method of claim 1, wherein at least one of the first diluent or the second diluent comprises a mineral oil having:
a density of about 0.85 g/cm³ to about 0.9 g/cm³ at 25° C.,
a kinematic viscosity at 25° C. of about 150 cSt to about 200 cSt, and
an average molecular weight of about 400 g/mol to about 600 g/mol,
and optionally wherein at least one of the first diluent or the second diluent further comprises a wax, the wax having:
a density of about 0.7 g/cm³ (at 100° C.) to about 0.95 g/cm³ (at 100° C.),
a kinematic viscosity of about 5 mm²/s (at 100° C.) to about 30 mm²/s (at 100° C.), and
a boiling point of about 200° C. or greater.

27. (canceled)

28. The method of claim 25, wherein the first catalyst compound is represented by Formula (II):
Cp_{A}(A)Cp_{B}MXₙ (II)
wherein:
M is titanium, zirconium, or hafnium;
n is 0 or an integer from 1 to 4;
Cp_{A} and Cp_{B} are independently selected from the group consisting of substituted or unsubstituted cyclopentadienyl, substituted or unsubstituted indenyl, substituted or unsubstituted tetrahydroindenyl, and substituted or unsubstituted fluorenyl;
each X is independently selected from the group consisting of halogen, hydrides, C₁ to C₁₂ alkyls, C₂ to C₁₂ alkenyls, C₆ to C₁₂ aryls, C₇ to C₂₀ alkylaryls, C₁ to C₁₂ alkoxys, C₆ to C₁₆ aryloxys, C₇ to C₈ alkylaryloxys, C₁ to C₁₂ fluoroalkyls, C₆ to C₁₂ fluoroaryls, and C₁ to C₁₂ heteroatom containing hydrocarbons, amides, amines, phosphines, ethers, carboxylates, dienes, and substituted derivatives thereof; and
A is a divalent bridging group containing at least one Group 13 to 16 atom.

29. The method of claim 28, wherein A is selected from the group consisting of methylene, ethylene, dimethylsilyl, diethylsilyl, methyl-ethylsilyl, trifluoromethylbutylsilyl, bis(trifluoromethyl) silyl, di (n-butyl) silyl, di (n-propyl) silyl, di (i-propyl) silyl, di (n-hexyl) silyl, dicyclohexylsilyl, diphenylsilyl cyclohexylphenylsilyl, t-butylcyclohexylsilyl, di (t-butylphenyl) silyl, and di (p-tolyl) silyl.

30. The method of claim 28, wherein the first catalyst compound is selected from the group consisting of (CH₃)₂Si (4,5,6,7-tetrahydroindenyl)₂Zr(CH₃)₂, (CH₃)₂Si (4,5,6,7-tetrahydroindenyl)₂ZrCl₂, (CH₂CH₃)₂Si (4,5,6,7-tetrahydroindenyl)₂Zr(CH₃)₂, (CH₂CH₃)₂Si(4,5,6,7-tetrahydroindenyl)₂ZrCl₂, ((CH₃)₂Si) 2 (4,5,6,7-tetrahydroindenyl)₂Zr(CH₃)₂, ((CH₃)₂Si)₂(4,5,6,7-tetrahydroindenyl)₂ZrCl₂, (CH₃)₂Si (4,5,6,7-tetrahydroindenyl)₂Hf(CH₃)₂, (CH₃)₂Si(4,5,6,7-tetrahydroindenyl)₂HfCl₂, (CH₂CH₃)₂Si (4,5,6,7-tetrahydroindenyl)₂Hf (CH₃)₂, (CH₂CH₃)₂Si(4,5,6,7-tetrahydroindenyl)₂HfCl₂, ((CH₃)₂Si) 2 (4,5,6,7-tetrahydroindenyl)₂Hf (CH₃)₂, ((CH₃)₂Si)₂(4,5,6,7-tetrahydroindenyl)₂HfCl₂, and combinations thereof.

31. The method of claim 30, wherein the first catalyst compound is (CH₃)₂Si(4,5,6,7-tetrahydroindenyl)₂Zr(CH₃)₂.

32. The method of claim 24, wherein the polyethylene copolymer has:
a bimodal composition distribution,
a density of about 0.914 g/cm³ to about 0.925 g/cm³, and
a melt index of about 0.1 g/10 min to about 1 g/min.

33. The method of claim 32, wherein the polyethylene copolymer has a melt index of about 0.3 g/10 min to about 0.8 g/10 min and wherein the polyethylene copolymer has a high load melt index (HLMI) of about 45 g/10 min to about 70 g/10 min.

34. The method of claim 32, wherein the polyethylene copolymer has an olefin comonomer content of about 5 wt % to about 10 wt % and wherein the polyethylene copolymer has a molecular weight distribution (MWD) of about 4 to about 7.

35. (canceled)

36. The method of claim 32, wherein the polyethylene copolymer has a melt index ratio (MIR) of about 40 to about 60.

37. (canceled)

38. The method of claim 32, wherein the polyethylene copolymer has a g′vis value of about 0.7 to about 0.94.

39. The method of claim 25, wherein the first catalyst compound is represented by Formula (I):
Cp_{A}Cp_{B}MXₙ (I)
wherein:
M of Formula (I) is titanium, zirconium, or hafnium;
n of Formula (I) is an integer from 0 to 4;
each Cp_{A} and Cp_{B} of Formula (I) is independently selected from the group consisting of substituted or unsubstituted cyclopentadienyl, substituted or unsubstituted indenyl, substituted or unsubstituted tetrahydroindenyl, and substituted or unsubstituted fluorenyl; and
each X of Formula (I) is independently selected from the group consisting of a halogen, a hydride, a C₁ to C₁₂ alkyl, a C₂ to C₁₂ alkenyls, a C₆ to C₁₂ aryl, a C₇ to C₂₀ alkylaryl, a C₁ to C₁₂ alkoxy, a C₆ to C₁₆ aryloxy, a C₇ to C₈ alkylaryloxy, a Ci to C₁₂ fluoroalkyl, a C₆ to C₁₂ fluoroaryl, a C₁ to C₁₂ heteroatom containing hydrocarbon, an amide, an amines, a phosphine, an ether, a carboxylate, a diene, and substituted derivatives thereof.

40. The method of claim 39, wherein the first catalyst compound is selected from the group consisting of:
bis(ethylcyclopentadienyl)Zr(CH₃)₂,
bis(ethylcyclopentadienyl)ZrCl₂,
bis(ethylcyclopentadienyl)Hf(CH₃)₂,
bis(ethylcyclopentadienyl)HfCl₂,
(ethylcyclopentadienyl)(pentamethylcyclopentadienyl)ZrCl₂,
(ethylcyclopentadienyl)(pentamethylcyclopentadienyl)Zr(CH₃)₂,
(ethylcyclopentadienyl)(pentamethylcyclopentadienyl)HfCl₂,
(ethylcyclopentadienyl)(pentamethylcyclopentadienyl)Hf(CH₃)₂,
bis(n-propylcyclopentadienyl)Zr(CH₃)₂,
bis(n-propylcyclopentadienyl)ZrCl₂,
bis(n-propylcyclopentadienyl)Hf(CH₃)₂,
bis(n-propylcyclopentadienyl)HfCl₂,
(n-propylcyclopentadienyl,pentamethylcyclopentadienyl)ZrCl₂,
(n-propylcyclopentadienyl,pentamethylcyclopentadienyl)Zr(CH₃)₂,
(n-propylcyclopentadienyl,pentamethylcyclopentadienyl)HfCl₂,
(n-propylcyclopentadienyl,pentamethylcyclopentadienyl)Hf(CH₃)₂,
bis(n-butylcyclopentadienyl)Zr(CH₃)₂,
bis(n-butylcyclopentadienyl)ZrCl₂,
bis(n-butylcyclopentadienyl)Hf(CH₃)₂,
bis(n-butylcyclopentadienyl)HfCl₂,
(n-butylcyclopentadienyl,pentamethylcyclopentadienyl)ZrCl₂,
(n-butylcyclopentadienyl,pentamethylcyclopentadienyl)Zr(CH₃)₂,
(n-butylcyclopentadienyl,pentamethylcyclopentadienyl)HfCl₂,
(n-butylcyclopentadienyl,pentamethylcyclopentadienyl)Hf(CH₃)₂,
and combinations thereof.

41. The method of claim 40, wherein the first catalyst compound is bis(n-propylcyclopentadienyl)Hf(CH₃)₂ or bis(n-propylcyclopentadienyl)Hf(Cl)₂.

42. The method of claim 39, wherein the polyethylene copolymer has:
a bimodal composition distribution,
a density of about 0.914 g/cm³ to about 0.925 g/cm³, and
a melt index of about 0.1 g/10 min to about 1 g/min.

43. The method of claim 42, wherein the polyethylene copolymer has a melt index of about 0.3 g/10 min to about 0.8 g/10 min and wherein the polyethylene copolymer has a high load melt index (HLMI) of about 1 g/10 min to about 25 g/10 min.)

44. The method of claim 39, wherein the polyethylene copolymer has an olefin comonomer content of about 5 wt % to about 10 wt % and wherein the polyethylene copolymer has a molecular weight distribution (MWD) of about 4 to about 7.

45. (canceled)

46. The method of claim 39, wherein the polyethylene copolymer has a melt index ratio (MIR) of about 40 to about 60.

47. (canceled)

48. The method of claim 39, wherein the polyethylene copolymer has a g′vis value of about 0.7 to about 0.97.

49. (canceled)
